(19) United States
(12) Patent Application Publication
(10) Pub. No.: US 2024/0127378 A1
(43) Pub. Date: Apr. 18, 2024

(54) APPARATUSES AND METHODS FOR RUNOFF ASSESSMENT AT A LOCATION

(71) Applicant: Honda Motor Co., Ltd., Tokyo (JP)

(72) Inventor: Andrew Edwin BEJCEK, Saline, MI (US)

(21) Appl. No.: 17/965,225

(22) Filed: Oct. 13, 2022

(51) Int. Cl. G06Q 50/16; A01C 7/00; A01G 20/30

(52) U.S. Cl. CPC G06Q 50/163; A01C 7/008; A01G 20/30

(57) ABSTRACT

Systems and methods are provided to assess water/rain runoff conditions at an area such as a turf or lawnscape. The system can include a computer processor (CP) and a database. The processing can include (a) inputting first data regarding a first candidate ingredient or operation to be considered for application (recommendation, initiation, etc.) to the area; (b) inputting second data regarding a second candidate ingredient or operation to be considered for application to the area; (c) inputting third data including a runoff score for the area; (d) determining a selected candidate ingredient or operation based on the runoff score; and (e) applying the selected candidate ingredient or operation to the area.

### BACKGROUND

The disclosed subject matter relates to methods and apparatuses that monitor the condition of a geographical area. More particularly, the disclosed subject matter relates to methods and apparatuses that monitor runoff conditions on a lawn, or other area, and related operations and processing.

Manual tools, manually operated machines, powered tools and powered machines can be used to create and maintain a landscape for a residential property or a commercial property. The manual tools and machines can be referred to collectively as manual equipment and include, but are not limited to, a rake, a shovel, a hoe, an aerator, pruning shears, a pruning saw, and a lawnmower. The powered tools and powered machines can be driven by an internal combustion engine or an electric motor or a hybrid of an internal combustion engine and an electric motor. The powered tools and machines can be referred to collectively as powered equipment or power equipment and include, but are not limited to, a string trimmer, a hedge trimmer, a power saw, a lawnmower, a tiller, a snowblower, and a garden tractor.

Residential property owners, property managers and commercial property owners can manage the care of the lawn and other vegetation forming the landscape of the property on their own or through a professional landscape service or both. Do-it-yourself (“DIY”) lawncare can require the property owner/manager to invest in the purchase of any number of manual equipment and/or powered equipment. DIY lawncare can also require a substantial amount of time to perform the various tasks/duties required to achieve the desire aesthetics for the landscape of the property. Further, DIY lawncare can require the property owner/manager to perform repairs and preventative maintenance on the manual equipment and/or the powered equipment. The property owner/manager can perceive the repair and maintenance activates as an inconvenience or an undesirable obstacle for maintaining the desired aesthetics of the landscape.

As an alternative to DIY lawncare, a property owner/manager can employ the services of a professional landscaper to maintain the health and appearance of vegetation on the property at the desired level of aesthetics. A professional landscape service can have access to a wide variety of manual equipment and powered equipment that can permit the professional landscaper to execute the desire lawncare treatment more effectively and/or efficiently than the property owner/manager. However, the cost of the professional landscape services can outweigh the convenience to the property owner/manager.

### SUMMARY

In accordance with an embodiment of the disclosed subject matter, a system to assess runoff conditions for an area at a geographical location, the system including a tangibly embodied computer processor (CP) and a tangibly embodied database, the CP implementing instructions on a non-transitory computer medium disposed in the database, and the database in communication with the CP, the system can include: a communication portion for providing communication between the CP and a user device; the database that includes the non-transitory computer medium, and the database including the instructions; and the CP, and the CP performing processing including: inputting first data regarding a first candidate operation to be considered for application to the area; inputting second data regarding a second candidate operation to be considered for application to the area; inputting third data including a runoff score for the area; determining a selected candidate operation based on the runoff score, the first data and the second data.

In accordance with another embodiment of the disclosed subject matter, an apparatus to assess runoff conditions for an area at a geographical location, the apparatus including a tangibly embodied computer processor (CP) and a tangibly embodied database, the CP implementing instructions on a non-transitory computer medium disposed in the database, and the database in communication with the CP, the apparatus can include: a communication portion for providing communication between the CP and a user device; the database that includes the non-transitory computer medium, and the database including the instructions; and the CP, and the CP performing processing including: inputting first data regarding a first candidate operation to be considered for the area; inputting second data regarding a second candidate operation to be considered for the area; inputting third data including a runoff score for the area; determining a selected candidate operation based on the runoff score, the first data and the second data, and the first data including first impact factors associated with the first candidate operation, and the first impact factors associated with respective weightings; the second data including second impact factors associated with the second candidate operation, and the second impact factors associated with respective further weightings; and the determining the selected candidate operation includes: the CP determining that the selected candidate operation is the first candidate operation based on the first data, the second data and the third data; and one of recommending and initiating the first operation candidate to the area.

In accordance with another embodiment of the disclosed subject matter, a method to assess runoff conditions for an area at a geographical location, the method performed by a system including a tangibly embodied computer processor (CP) and a tangibly embodied database, the CP implementing instructions on a non-transitory computer medium disposed in the database, and the database in communication with the CP, the method can include: inputting first data regarding a first candidate operation to be considered for the area; inputting second data regarding a second candidate operation to be considered for the area; inputting third data including a runoff score for the area; determining a selected candidate operation based on the runoff score, the first data and the second data, and the first data including first impact factors associated with the first candidate operation, and the first impact factors associated with respective weightings; the second data including second impact factors associated with the second candidate operation, and the second impact factors associated with respective further weightings; and the determining the selected candidate operation includes: the CP determining that the selected candidate operation is the first candidate operation based on the first data, the second data and the third data; and one of recommending via a user interface and initiating via machine the selected candidate operation to the area.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a schematic view of a prescriptive lawncare system made in accordance with principles of the disclosed subject matter.

FIG. 2 is flowchart that outlines the general operation of the prescriptive lawncare treatment system of FIG. 1 in accordance with principles of the disclosed subject matter.

FIG. 3 is a block diagram showing details of the processing device shown in FIG. 1, in accordance with principles of the disclosed subject matter.

FIG. 4 is a high-level flowchart showing processing including “runoff assessment controller (RAC) performs post-application runoff processing (PARO processing), in accordance with principles of the disclosed subject matter.

FIG. 5 is a flowchart showing details of “RAC performs processing to determine lawn runoff score” of a subroutine, in accordance with principles of the disclosed subject matter.

FIG. 6 is a flowchart showing details of “RAS performs analysis of predetermined soil parameter(s) to determine runoff score” of a subroutine, in accordance with principles of the disclosed subject matter.

FIG. 7 is a flowchart showing details of “RAC engages with user to select parameters for PARO processing, including inputting criteria and respective weighting selection” of a subroutine, in accordance with principles of the disclosed subject matter.

FIG. 8 is a flowchart showing details of “RAC performs processing to perform ingredient determination so as to determine what ingredient to recommend” of a subroutine, in accordance with principles of the disclosed subject matter.

FIG. 9 is a flowchart showing details of “RAC determines a weighted total score for a current candidate ingredient” of a subroutine, in accordance with principles of the disclosed subject matter.

FIG. 10 is a schematic diagram showing analysis of a lot map, in accordance with principles of the disclosed subject matter.

FIG. 11 is a schematic diagram showing a data table, in accordance with principles of the disclosed subject matter.

FIG. 12 is a schematic diagram showing instances of data tables, in accordance with principles of the disclosed subject matter.

FIG. 13 is a schematic diagram of a user device displaying a graphical user interface (GUI), in accordance with principles of the disclosed subject matter.

FIG. 14 is a flowchart showing details of processing in which the RAC determines a runoff score based on a model, in accordance with principles of the disclosed subject matter.

FIG. 15 is a flowchart showing details of processing in which the RAC controls the modeling portion 118 to process a target lawn section, in accordance with principles of the disclosed subject matter.

FIG. 16 is a schematic diagram showing aspects of data processing in an illustrative modeling process, in accordance with principles of the disclosed subject matter.

FIG. 17 is a schematic diagram illustrating further aspects of modeling processing, in accordance with principles of the disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

The disclosed subject matter is directed to an apparatus and method for determining a lawn treatment plan and delivering lawn treatments particularly with respect to runoff issues at the target location. In one embodiment, prescriptive lawncare system (“PLC system”) 10 can include a user interface that receives an address having a lawn. The system 10 can include calculating a lawn treatment plan based on the initial lawn size. The system 10 can further include providing the lawn treatment plan to a customer via a user device 130 and then providing the lawn treatment plan to a fulfillment center. The system 10 also contemplates delivering packetized lawn treatments according to the lawn treatment plan on a periodic basis to the customer for treatment of the lawn. Soil samples can frequently be monitored, sensed, or input into the system 10 to determine moisture content, type, and other variables associated with the soil. The system 10 can be configured to provide post-application runoff information to the user such that various actions can be taken, recommended or recorded. For example, after runoff is detected or predicted, the system 10 can recommend, schedule, or perform seeding of certain types of plants, grading certain areas of the target property, applying chemicals, fertilizers, soils, materials, at certain areas of the target property, as well as other outputs, operations, or activities associated with preventing or controlling runoff.

Different types of soil have different types of absorption characteristics, and runoff risk can be different for each type of soil with respect to other types of soils or combinations of soils. The system 10 can include sensor(s) that provide absorption, moisture, and other information related to soil at a particular geographic location, and deliver that information to a processing device 100. Based on this information the processing device 100 can calculate various predictive information, such as how much growth (grass or other vegetation) is likely to occur at that location, and thus predict whether runoff is likely to occur at the location (e.g., if less growth is predicted and possibly other variables such as high slope, low absorption, etc., are present then runoff may be predicted).

The system 10 can also be used to determine, provide recommendations, make purchases, or begin operation or processes related to a target lawn location(s). For example, a weather forecast can be referenced by or input into the system 10 and the system 10 can be configured to recommend ideal application or operation time so as to minimize possible runoff. Thus, if gentle rain is predicted, operations such as fertilizing, seeding, thatching, planting, watering, cutting, etc., can be recommend to or initiated by user device 130.

In another example in which well water or a limited water supply is available to a user, the system 10 can be configured to provide a warning to a user if a runoff condition is determined. The system 10 can also provide a recommended action or can be configured to operate in a manner that prevents over watering of the target location, thereby also preventing runoff conditions. The system 10 can also be configured integrally with machines or tools to cause or prevent watering of the target location, thereby also preventing runoff conditions.

The system 10 can also be configured to provide recommendations or cause certain operations after a runoff event has occurred. For example, the system 10 can include soil sensors that determine or sense various properties of the soil at a given time. If the properties are different at a different time, the system 10 can determine that a runoff has occurred and then make recommendations, purchases, or initiate operations related to mediation of the harm of the runoff and/or in order to prevent future runoff conditions. In one example, the system 10 can recommend or prevent further watering of a property if runoff has been determined by the system 10. As indicated above, if measurement of potential runoff is desired, the system 10 can obtain weather data, almanac data, gradient or slope data, soil type, or other data to predict potential runoff in the future and make recommendations or initiate operations based on the predicted runoff.

The system 10 can further include modeling aspects for operation. For example, if the system 10 learns that a certain treatment or operation at a certain location was successful, the treatment and operation parameters can be stored to a database, as will be explained in more detail below. If future target locations include similar variables (e.g., slope, soil type, soil density, weather conditions, pH, etc.) then a similar treatment or operation can be applied to the new target location based on the successful outcome and operational and treatment parameters stored from model location(s).

In one exemplary embodiment of the system 10, soil type and slope can be used as tools to estimate a propensity for runoff, based on either measured data from a target location or based on modeled data from similar locations. A table of coefficients can be used to estimate propensity for different soil types to absorb water (and/or other ingredients). This table of coefficients can be built into or the basis for a weighting system, as described in more detail below, that allows software to use this information to predict certain characteristics of a target location.

In another exemplary embodiment of the system 10, operation and/or treatment can be further varied depending on weather characteristics. For example, if rain is predicted, the system 10 can delay or speed up proposed operations and/or applications of ingredients at the target location. The weather information can be obtained various manners, for example, in real time via connection to the internet, via historical data such as almanacs etc., via seasoanality characteristics for a particular locations, etc. Other environmental considerations can be factored into decision protocols for the system 10. In particular, distances from ponds and lakes and other bodies of water can factor into when and how operations are conducted and what ingredients to apply to a target location. Local, state and national regulations can also be input or otherwise considered decision protocols for the system 10.

It is contemplated that through the use of artificial intelligence, the system 10 could be trained to create or develop its own coefficients related to soil absorption based on soil density and/or other variables and characteristics for a target location. Soil density can be measured in various manners, and is more of a qualitative characteristic as opposed to a quantitative characteristic. Soil density can be measured, for example, by taking a core sample of a known volume and weighing it. Thus, through machine learning, when the system 10 is used for many different locations, an ideal operation/application protocol can be determined for a target location based on past experience (e.g., through modeling and machine learning, that determines soil absorption and/or soil density characteristics in various manners and then correlates them together for predicting each other for future use, as will be described in more specific detail below).

Lawn care operations controlled or recommended by the system 10 can include routine cutting, trimming, and pruning the vegetation that forms a property landscape, watering, chemical treatment, planting, seeding, aeration and/or dethatching, and leveling or grading the lawn. A property owner/manager can completely lack experience in basic lawncare or have very limited experience with lawncare. Further, a property owner/manager might have only a basic understanding for diagnosing the health of the property's landscape and/or how to effect treatment of the landscape to improve or maintain the health of the landscape, such as effecting proper runoff (e.g., water and/or rain runoff) to occur on the property. Thus, there is a need for a prescriptive lawncare service that can help a property owner/manager to prevent or control runoff, and diagnose the current health of the property's landscape, maintain the health, modify the landscape to improve appearance and/or runoff conditions, achieve the desired aesthetics and runoff characteristics, and perform the routine maintenance such as but not limited to cutting of the lawn, watering the lawn, etc.

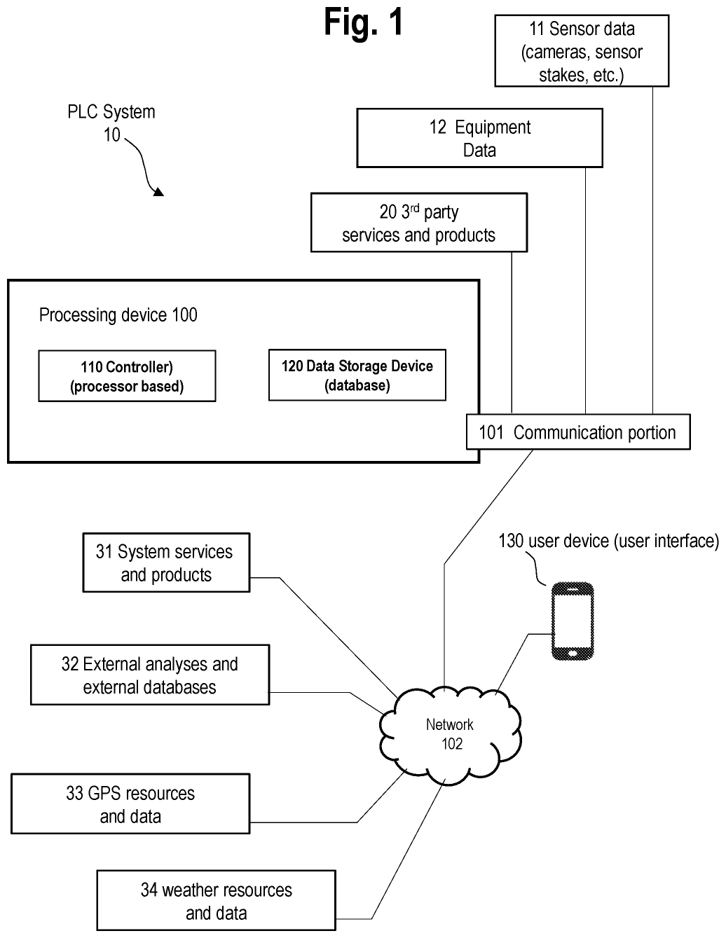

FIG. 1 is a schematic illustration of a prescriptive lawncare system (“PLC system”) 10 that can provide property owners/managers and professional landscapers with information about a relevant landscape, formulate a treatment plan for the landscape, recommend service(s) and equipment for executing the treatment plan, and/or provide instructions for executing the treatment plan. The PLC system 10 can include data processing device or system 100 (hereinafter “processing device 100”), sensor data 11, equipment data 12, and other processing and/or data resources. The PLC system 10 can include third party services and systems 20 that can include external services and systems. The PLC system 10 can include system services and products 31, external analyses and external database resources 32, global positioning satellite (“GPS”) resources and data 33, and weather resources and data 34.

The processing device 100 can include a communication portion 101, a processor-based controller 110, and a data storage device 120.

The communication portion 101 can be electrically connected and in communication with the various components of the PLC system 10, as shown in FIG. 1. Such electrical connection and communication can be provided over a network 102 or over some other communication mechanism or arrangement.

FIG. 1 schematically illustrates respective lines or communication lines connecting the communication portion 101 to each of the data inputs 11, 12, the providers 20, 31, 32, 33, 34, and the user interface 130. These lines can schematically represent a wired connection or a wireless connection. The electrical communication can be over a local computer network, or over the internet, or over a cellular network, or any combination these networks or over some other communication mechanism. The electrical communication can be over network 102, as shown in FIG. 1. The communication portion 101 can pass data and/or information between the controller and each of the data inputs 11, 12, the providers 20, 31, 32, 33, 34, and the user interface 130.

The sensor data 11 can include data indicative of the color and density of a lawn, the moisture content, soil type, slope, sunlight exposure, and other attributes. The sensor data 11 can be obtained by any appropriate device(s) such as but not limited to a camera, sensor stakes, etc.

The equipment data 12 can include the type of lawncare equipment that is owned by the property owner/manager, the type lawncare equipment owned by one or more neighbors, and/or the type of lawncare equipment being used on the property or location by a professional landscape service. The equipment data can include data indicative of handheld tools, walk-behind machines, and ride-on machines. The equipment data can include attributes of the equipment including whether the equipment is manually operated, powered by an internal combustion engine, powered by an electric motor, or powered by a hybrid of an internal combustion engine and electric motor. The equipment data can include data indicative of the hours of operation, the maintenance schedule, completed maintenance, etc., for each piece of equipment.

The user interface 130 can be in the form of a user device 130. The user interface can be any appropriate electronic device, such as, but not limited to, a cellular (mobile) telephone, a tablet computer, a laptop computer, a desktop computer, a server terminal, that can permit a user to input requests for information to and receive information generated by the processing device 100.

The GPS resources and data 33 can include satellite image(s) of the property and neighboring properties, street level image(s) of the property and neighboring properties. map data of the property and neighboring properties, and address information of the property and neighboring properties. Any number of user interfaces 130 can be in electrical communication with the processing device 100.

The weather resources and data 34 can include data indicative of temperature (daily highs and lows, averages, maximums, minimums, current) precipitation amounts, amount of sunshine (average, maximums, minimums, current). The weather data 34 can be obtained from a service provider or government agency.

In general, inputs into the processing device 100 can be electrically connected to data sources such as, but not limited to, a soil sample analysis, geographic information, lawn scan and mapping data, and regulation/ordinance information. Data representing soil sample analysis can be provided by a third party or determined by the controller 110 using data output by a soil analysis apparatus in electrical communication with the controller 110, where the output data is based on a soil sample introduced to an analysis apparatus by the user. Lawn scan and mapping data can be based on data obtained from, but not limited to, a formal land survey, satellite imagery, a digital image scan of the landscape, and government agency(ies) such as the U.S. Geological Survey and U.S. Department of Agriculture. Regulation/ordinance information can be obtained from any appropriate local, regional or national government agency or from a subscription database of local, regional and national regulations and ordinances.

The processing device 100 can generate outputs, through electrical communication, to the user interface 130 and the service and/or equipment providers. The processing device 100 can output a treatment plan and/or other information requested by the user and can output requests or notifications to the service and/or equipment providers based on the treatment plan and/or other information requested by the user.

The processor-based controller (“controller”) 110 can be a physically embodiment of a machine referred to as an electronic computing device such as but limited to an electronic control unit (“ECU”), a central processing unit (“CPU”), a microcontroller, a microcomputer, a server, a plurality of electronic computing devices or servers, or other appropriate processor-based controller(s) that can receive data inputs, execute commands for processing the data inputs, and output a treatment plan based on executed commands. The controller 110 can be configured with hardware alone or in combination with software to execute commands that process the data inputs and output any of a plurality of lawncare treatment plans in accordance with the disclosed subject matter. The controller 110 can be referred to as a product and service recommendation engine 110.

For example, the controller 110 can be configured to interact with the user interface 130 and permit a user to request a fertilizer plan for the landscape. The controller 110 can be configured to determine a fertilizer content and schedule based on data input by the user and data input from any appropriate data input(s). In another example, the controller 110 can be configured to permit the user to request a sunlight evaluation of the landscape based on measured sunlight data input to the controller 110 and recommend a treatment plan for the landscape based on the processed sunlight data. In yet another example, the controller 110 can be configured to permit the user to request an evaluation of the grade of the lawn and output a recommended adjustment of the grade and provide the user with instructions and recommendations on how to achieve the recommended grade. In yet another example, the controller 110 can be configured to permit the user to request a soil analysis of the landscape, recommend a treatment plan for the landscape soil, and provide a water runoff analysis after the user implements the treatment plan. In yet another example, the controller 110 can be configured to permit the user to select a desired aesthetic appearance of the landscape, recommend a treatment plan that can achieve the desired aesthetic appearance, and rank the recommended treatment plan according to predetermined parameters such as but not limited to difficulty, cost, equipment availability. The controller 110 can be in electrical communication with each of the data inputs 11, 12, the providers 20, 31, 32, 33, 34, and the user interface 130.

The data storage device 120 can be any appropriate non-transitory recording or storage medium such as, but not limited to, a CD-ROM, a DVD-ROM, a hard drive, a RAM, a ROM, a floppy disc, and a magnetic tape cassette, or later developed medium such as, but not limited to, transitory recording medium, or carrier waves. The data storage device 120 can include some or all of the software that is executed by the controller 110 in order to provide the treatment plan(s) requested by the user. The data storage device 120 can store data created by the controller 110 that is indicative of the one or more parameters of a landscape, lawn or location such as, but not limited to, grade, type(s) and location(s) of the vegetation, water-runoff analysis, scanned images, map information, soil analysis, coloration of the vegetation, chemical analysis of the vegetation. These parameters can be referred to as the digital lawn.

A provider of the PLC system 10 can be a manufacturer of lawncare equipment. The system services and products 31 can include lawncare products manufactured by the manufacturer, other service(s) offered by the manufacture and other products available from the manufacturer. The processing device 100 can communicate with the system services and products 31 to provide the user with suggested equipment, sales information, and other services/products. The sales information can include the location of a lessor, retailer or dealer of the suggested equipment. The controller 110 can be configured to send a message to the lessor, retailer or dealer indicative of the user's desire of or inquiry regarding the suggested equipment so that the lessor, retailer or dealer can initiate contact with the user about a possible sale or lease of the suggested lawncare equipment.

The manufacturer of lawncare equipment and provider of the PLC system 10 can also offer other services such as, but not limited to, professional landscaping, professional lawncare maintenance, and other products such as, but not limited to, portable generators, cars, pick-ups, sports-utility vehicle, cross-over vehicle, vans, motorcycles, all-terrain vehicle, outboard motors, and aircraft. The controller 110 can be configured to provide the user with information regarding any of the other products or offerings from the manufacture.

The external services and products 20 can be any third party entity not affiliated with the provider of the PLC system 10 such as, but not limited to, a manufacturer of fertilizer, a professional landscaper, or a rental company that leases lawncare equipment. The controller 110 can be configured to provide the user and any component of the external services and products 20 with information about each other.

For example, the controller 110 can be configured to output a message to a professional landscaper that indicates that the user is interested in hiring a professional landscaper. The controller 110 can be configured to obtain information from the landscaper such as cost, services provided and equipment used and provided this information to the user via the user interface or user device 130. For example, the landscaper can have traditional lawncare equipment that is operated by a designated person, or automated lawncare equipment that is operated remotely or fully autonomous.

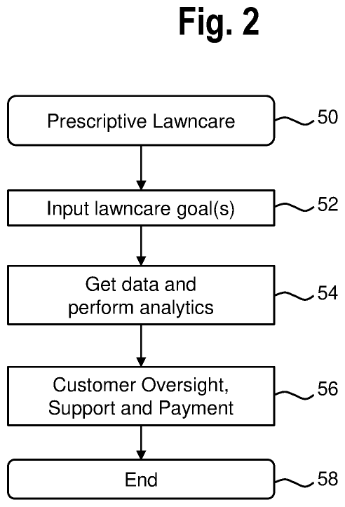

FIG. 2 is flowchart illustrating the general operation of the controller 110. At step 50, the user can initiate a prescriptive lawncare service session with the controller 110 via the user interface 130. The processing performed by the controller 110 can then move to step 52.

At step 52, the controller 110 can be configured to prompt the user to input one or more lawncare goals for the property or location. The controller 110 can be configured to move to step 54 when the user has entered desired goals to the controller 110 via the user interface 130.

At step 54, the controller 110 can be configured to access all of the data inputs 11, 12, the providers 20, 31, 32, 33, 34, and the user interface 130, that are appropriate to generate a treatment plan in accordance with the user's goal(s). After obtaining the data, the controller 110 can be configured to analyze the obtained data in accordance with predetermined processing, computations and comparisons. After completing the analysis, the controller 110 can move to step 56.

At step 56, the controller 110 can be configured to generate and output a treatment plan based on the analysis performed in step 54. The controller 110 can be configured to prompt the user to request or decline supplemental information regarding the treatment plan. The supplemental information can include information from the system services and products 30, information from the external services and products 40, instructions on how to execute the treatment plan, frequently asked questions (“FAQs”) related to the treatment plan, etc. At step 56, the controller 110 can be configured to accept payment from the user for the treatment plan and for any services and products ordered for the execution of the treatment plan.

After completing the payment(s), the controller 110 can be configured to end the prescriptive lawncare service session.

As an example of the execution of the flowchart of FIG. 2, the user can select or set a specific goal of the lawn at step 52 that indicates a lush, thick grass lawn. The controller 110 can execute one or more subroutines at step 54 that are predetermined for use in generating a treatment plan directed toward a lush, thick lawn. The subroutine(s) executed at step 54 can include steps to obtain data regarding the type of grass on the property, historical rainfall and temperature data for the property, grade of the lawn on property, historical sunlight data from the property, and soil analysis data for the property, and ordinances and regulations regarding chemical treatments to land in the jurisdiction of the property. The controller 110 can output a treatment plan at step 56 that includes the application of fertilizer and a list of chemical(s) that are permitted by ordinance/regulation for the property, and retailers of the permitted chemical(s). The controller 110 can be configured to prompt for and accept payment for the treatment plan and any chemical(s) (e.g., fertilizer(s)) ordered using the PLC system 10.

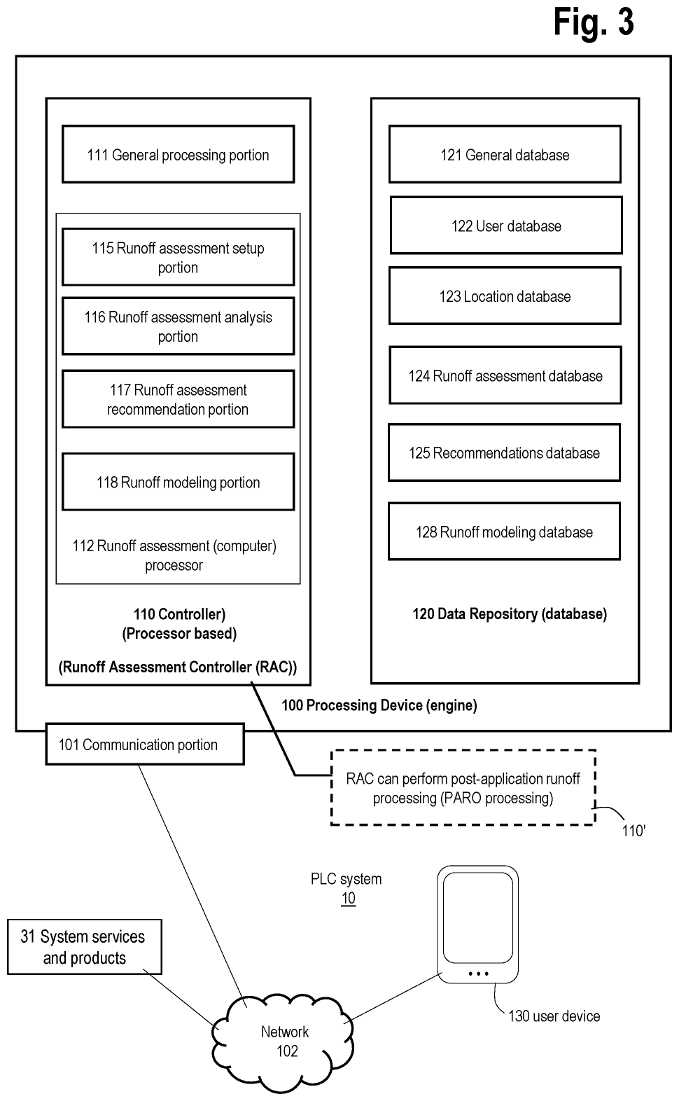

Hereinafter, further inventive aspects of the disclosure will be described with reference to FIGS. 3-13.

FIG. 3 is a block diagram showing further details of the processing device shown in FIG. 1, in accordance with principles of the disclosed subject matter. FIG. 3 illustrates further details of the PLC system 10. The processing device 100 can include controller 110 and data repository 120, as described above. The controller 110 can include a general processing portion 111. The general processing portion 111 can handle overall and more general processing of the processing device 100. The controller 110 can also include a runoff assessment processor 112. The runoff assessment processor 112 can perform processing to provide various functionality related to runoff assessment, as described in detail below. In accordance with principles of the disclosed subject matter, the controller 110 can be described as a runoff assessment controller (RAC) 110. The RAC 110 can include the runoff assessment processor 112.

The runoff assessment processor 112 can include a runoff assessment setup portion 115, a runoff assessment analysis portion 116, a runoff assessment recommendation portion 117, and a runoff modeling portion 118.

The data repository 120 or database 120 can include various databases or sub-databases. The database 120 can include a general database 121, a user database 122, a location database 123, a recommendations database 124, a runoff assessment database 125, and a runoff modeling database 128. The general database 121 can store various data related to overall operations of the processing device 100, including data utilized and generated by the controller 110. The user database 122 can store various data associated with users who utilize the processing device 100. The location database 123 can store various data related to locations that are serviced by or processed by the processing device 100. For example, such a location might be a lawn at a user's place of residence. The recommendations database 124 can store various data to map observed attributes into recommendations. Such recommendations can then be output to the relevant user. The runoff assessment database 125 can store various data utilized by and generated by the runoff assessment processor 112. For example, the runoff assessment database 125 can store data related to observed runoff conditions at a location over time.

As illustrated in FIG. 3, and described above, the PLC system 10 can include a user device 130. The user device can provide a user interface.

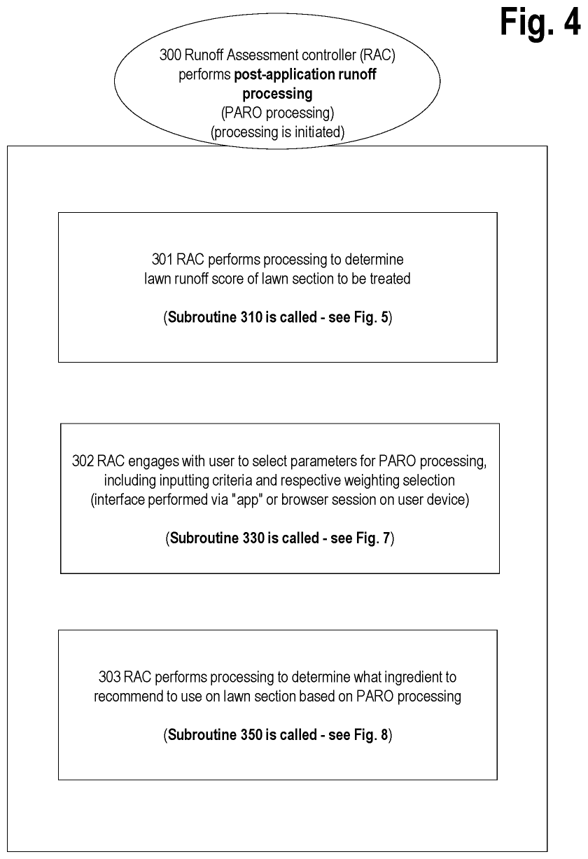

Hereinafter, further details will be provided regarding the RAC 110 and the various functionality provided by the RAC 110. FIG. 4 is a high-level flowchart showing processing that can be performed by the RAC 110. As reflected in step 300 of FIG. 4, the RAC 110 performs post-application runoff processing (PARO processing), in accordance with principles of the disclosed subject matter. The processing of step 300, shown in FIG. 4, can include various processing components including processing of steps 301, 302 and 303.

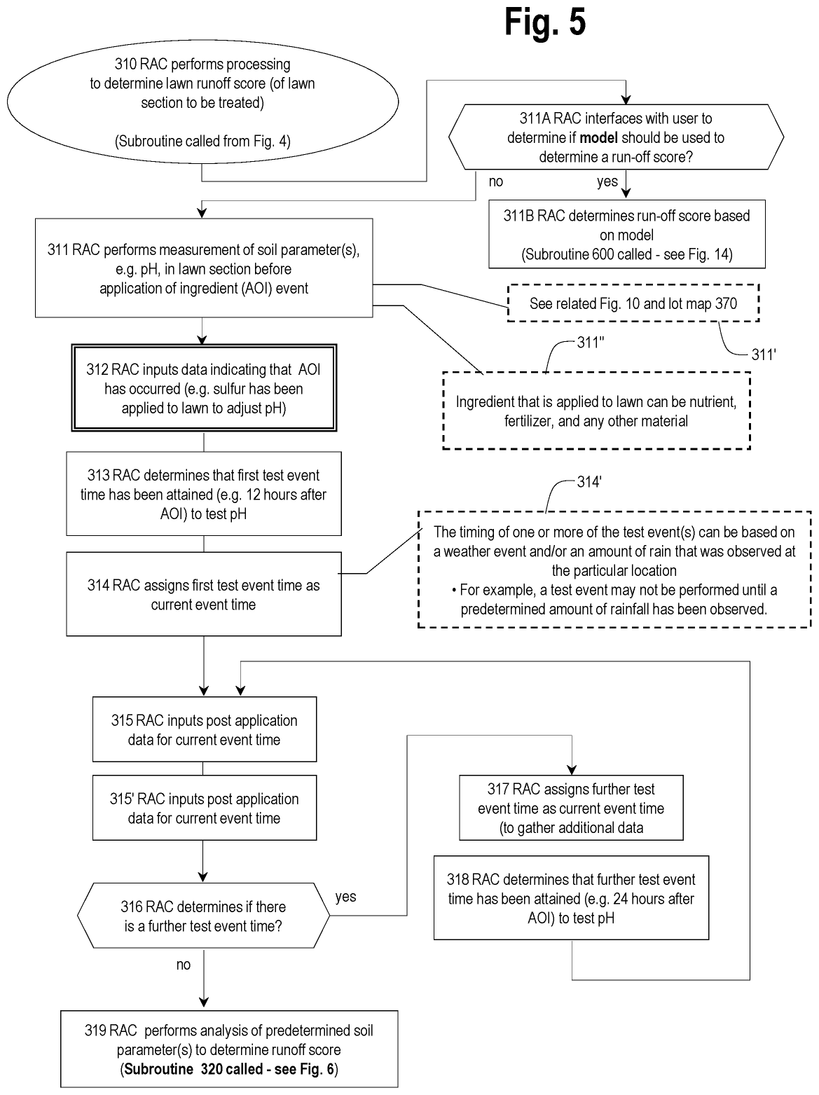

In step 301, the RAC 110 performs processing to determine a lawn runoff score of a lawn section to be treated. To perform such processing, a subroutine 310 can be called or invoked. Details of subroutine 310 are described below with reference to FIG. 5.

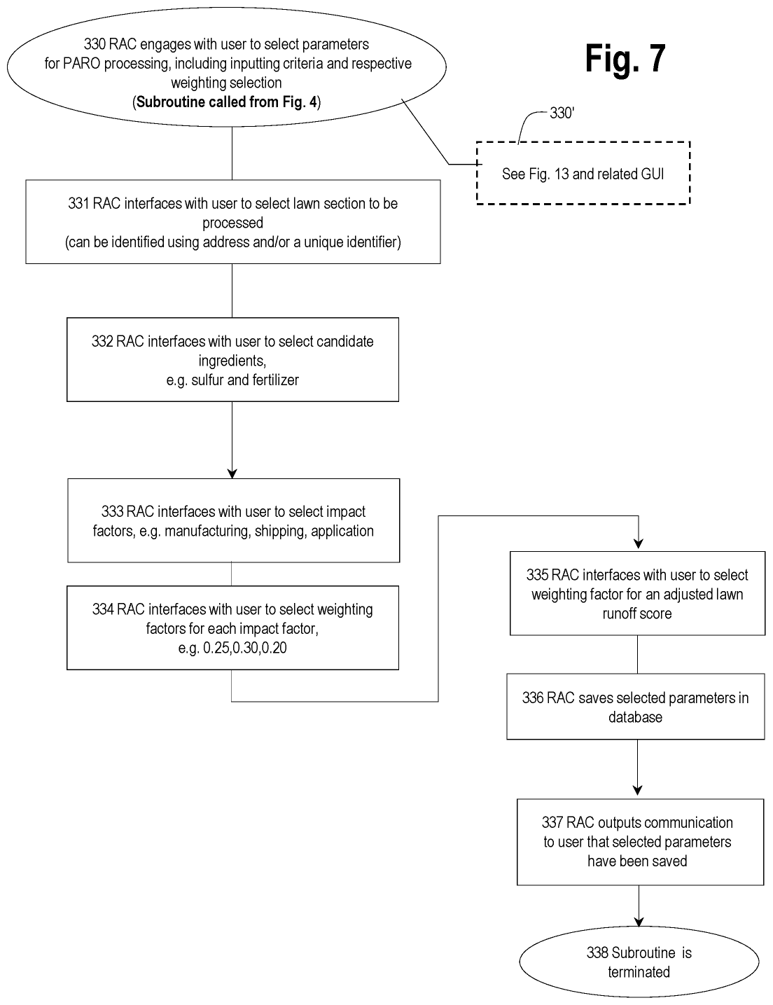

In step 302, the RAC 110 engages with user to select parameters for PARO processing, including inputting criteria and respective weighting selection. To perform such processing, a subroutine 330 can be called or invoked. Details of subroutine 330 are described below with reference to FIG. 7. The processing of step 302 can be initiated by interfacing with a user, and more specifically with the user device 130, and include interaction with the user via an app or via a browser session with the user device 130.

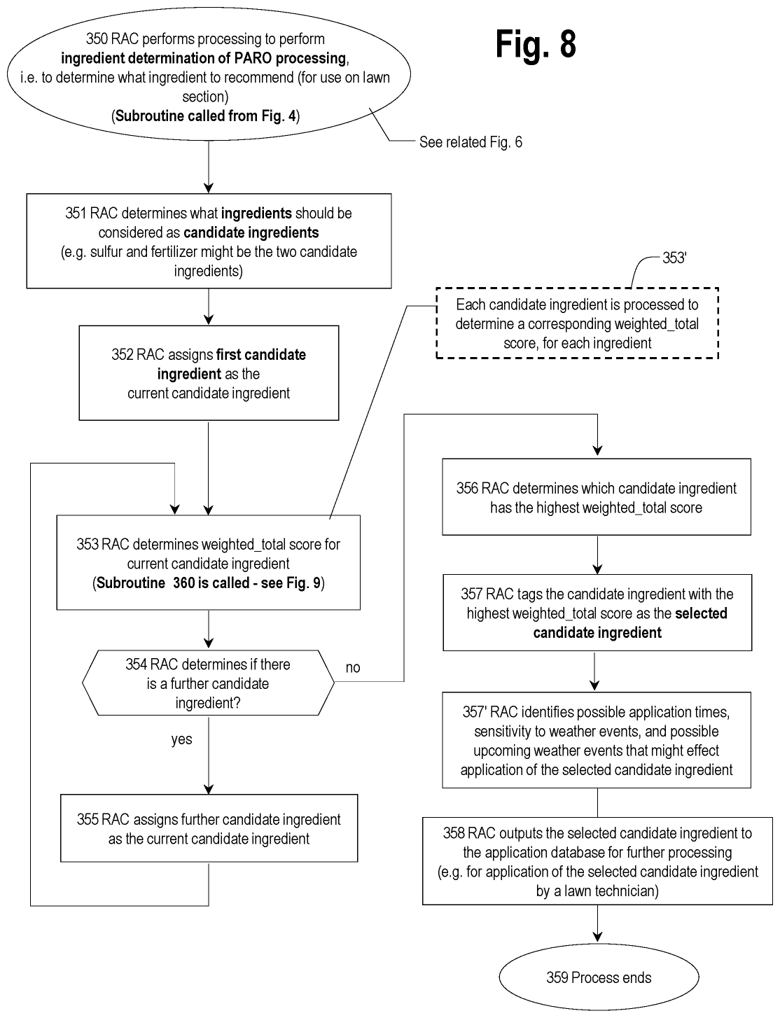

In step 303, the RAC 110 performs processing to determine what ingredient to recommend to use on lawn section based on PARO processing. To perform such processing, a subroutine 350 can be called or invoked. Details of subroutine 350 are described below with reference to FIG. 8.

FIG. 5 is a flowchart showing details of “RAC performs processing to determine lawn runoff score” of subroutine 310. The processing can be applied to a lawn section to be treated. The subroutine 310 can be called from the processing of FIG. 4. The processing is initiated and passes on to step 311A.

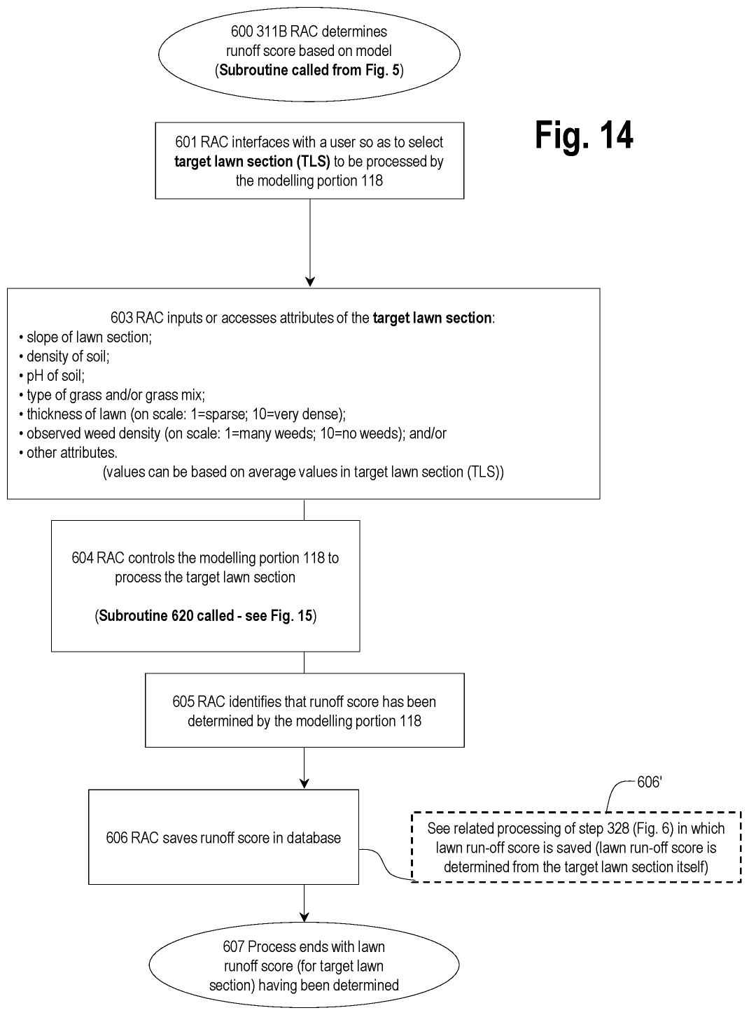

In step 311A, the RAC 110 interfaces with the user to determine if a model should be used to determine a runoff score for the lawn section to be treated. If yes, then the process passes on to step 311B. In step 311B, the RAC 110 determines a runoff score based on a model. To perform such processing, subroutine 600 can be called, as described below with reference to FIG. 14. If no in step 311A, the process passes to step 311. That is, rather than utilizing a model to determine a runoff score for the lawn section to be treated, a runoff score can be determined based on observation of the lawn section itself, as described below.

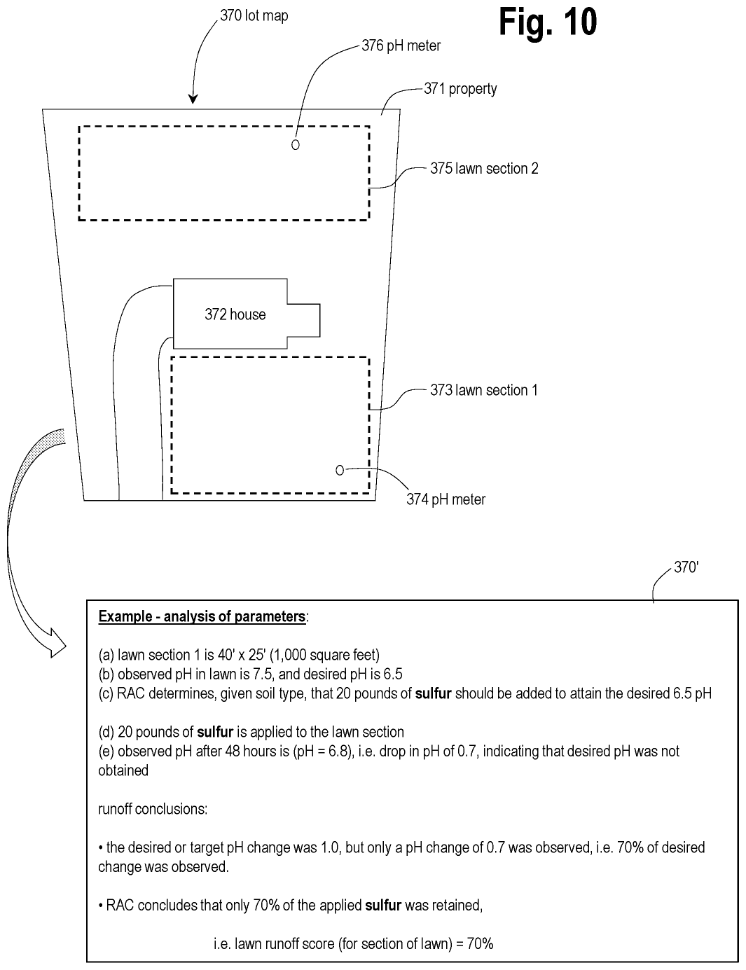

In step 311, the RAC performs measurement of soil parameter or parameters in the lawn section before an application of ingredient (AOI) event. For example, the soil parameter could be a pH of the lawn. As reflected at 311′, further details of the processing of step 311 are described below with reference to FIG. 10 and lot map 370. Then, the process passes onto step 312.

In step 312, the RAC inputs data indicating that the AOI event has occurred. For example, sulfur has been applied to the lawn to adjust pH of the lawn. Then, the process passes onto step 313. In step 313, the RAC determines that a first test event time has been attained. For example, the first test event time could be 12 hours after AOI. Then, in step 314, the RAC assigns the first test event time as the current event time. Then, the process passes onto step 315.

In step 315, the RAC inputs post application data for the current event time. Then, in step 315′, the RAC saves the post application data for the current event time. Then, in step 316, the RAC determines if there is a further test event time. If yes, then the process passes onto step 317. In step 317, the RAC 110 assigns the further test event time as the current event time. That is, the RAC assigns a further test event time so as to gather additional data. Then, the process passes onto step 318. In step 318, the RAC determines that further test event time has been attained. For example, the further test event time might be 24 hours after AOI at which time the pH of the soil will again be tested.

Accordingly, once the further test event time has been attained in step 318, then the process passes back to step 315. In step 315, process proceeds as described above.

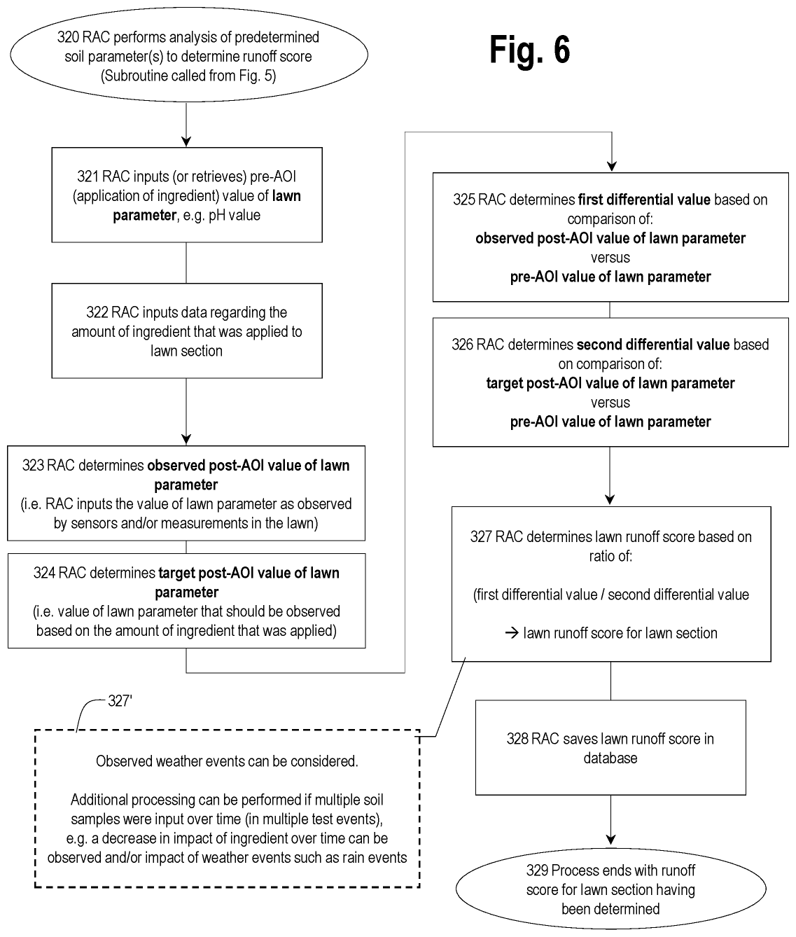

At a point in the processing, the RAC will determine that there is not a further test event time. That is, a no will be rendered in step 316. As a result, the process passes onto step 319. In step 319, the RAC performs analysis of predetermined soil parameter(s) to determine runoff score. Such processing can be performed by subroutine 320 as shown in FIG. 6.

As reflected at 311″, an ingredient that is applied to the lawn can be a nutrient, fertilizer, water, gradient fill material, seeds, plants, soil, and any other material, chemical, or substance as desired.

As described above, in step 314, the RAC assigns a first test event time as the current event time. As noted at 314′, the timing of one or more of the test event(s) can be based on whether an event and/or an amount of rain that was observed at the particular location. The timing of the test event can also be based on a wide variety of other parameters, weather considerations, temperature considerations, weather history that could go back hours, days, weeks, or months, type of soil, type of grass or other vegetation, or any other consideration or parameter. For example, a test event might not be performed until a predetermined amount of rainfall has been observed, so as to best measure runoff under predetermined conditions.

FIG. 6 is a flowchart showing details of “RAS performs analysis of predetermined soil parameter(s) to determine runoff score” of subroutine 320, in accordance with principles of the disclosed subject matter. Subroutine 320 can be called from the processing of FIG. 5. The subroutine is initiated and passes onto step 321.

In step 321, the RAC 110 inputs, or retrieves from memory, a pre-AOI value of a lawn parameter. For example, the lawn parameter could be a pH value, or grass height, or moisture value for the soil, which is input from a sensor in the lawn section or input from the user. Then, in step 322, the RAC 110 inputs data regarding the amount of ingredient that was applied to the particular lawn section. Then, in step 323, the RAC 110 determines the observed post-AOI value of the lawn parameter. For example, this input to the RAC 110 can be based on the value of lawn parameter as observed by sensors and/or other measurements taken or observed from the lawn. Then, the process passes on to step 324.

In step 324, the RAC 110 determines the target post-AOI value of the lawn parameter. Such target post-AOI value of the lawn parameter is the value that should be observed based on the amount of ingredient that was applied to the lawn section. Accordingly, step 323 provides the value before the application of a particular ingredient. Step 324 determines the value that should be observed after application of the particular ingredient, assuming that no runoff has occurred. Then, the process passes onto step 325.

In step 325, the RAC 110 determines a first differential value based on a comparison of (1) the observed post-AOI value of the lawn parameter versus (2) the observed pre-AOI value of the lawn parameter.

Then, in step 326, the RAC 110 determines a second differential value based on a comparison of the (1) the observed target AOI value of the lawn parameter versus (2) the observed pre-AOI value of the lawn parameter. The processing then passes onto step 327.

In step 327, the RAC 110 determines a lawn runoff score. The lawn runoff score is based on a ratio of the first differential value over or compared to the second differential value. It is appreciated that other mathematical methodologies could be used to determine the ratio. As result of the processing of step 327, a lawn runoff score for the lawn section is determined.

As reflected at 327′, in the processing of step 327, observed weather events can be considered. Additional processing can be performed if multiple soil samples were input over time (in multiple test events). For example, a decrease in impact of ingredient over time may be observed and/or other impacts of weather events, such as rain events, can be observed. The RAC 110 can perform processing so as to take such events into account in the processing of step 327.

After step 327, the process passes onto step 328. In step 328, the RAC 110 saves the runoff score in a database. For example, the RAC 110 can save the lawn runoff score in the data repository 120, and specifically in the runoff assessment database 124, as shown in FIG. 3.

With further reference to FIG. 6, after step 328, the process passes onto step 320. In step 329, the process ends with the runoff score for the lawn section having been determined. It is appreciated that the processing of FIG. 6 can be performed on an ongoing basis over time. Prior determined runoff values can be averaged or otherwise combined with a current or present runoff value. Accordingly, over time, a more accurate runoff value of a particular lawn section can be generated by the RAC 110.

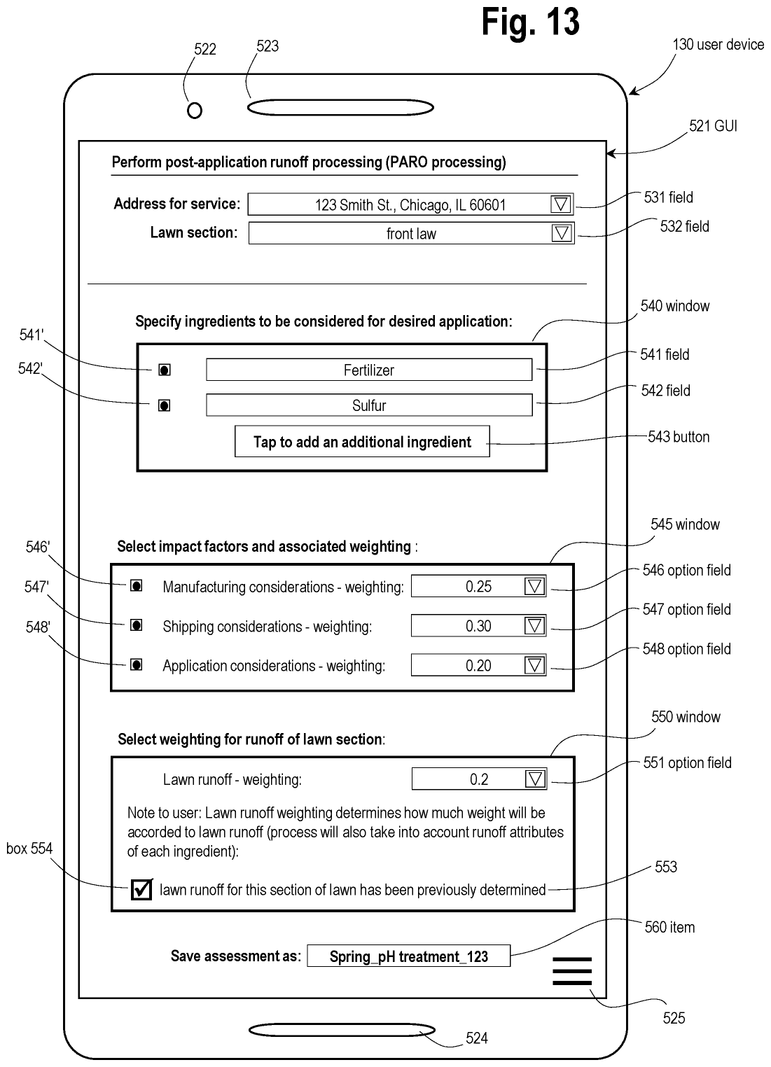

FIG. 7 is a flowchart showing details of “RAC engages with user to select parameters for PARO processing, including inputting criteria and respective weighting selection” of subroutine 330, in accordance with principles of the disclosed subject matter. Subroutine 330 can be called from the processing of FIG. 4. The processing shown in FIG. 7 can be performed by the RAC 110 interfacing with the user via an “app” or browser session on user device. FIG. 13 shows a GUI 521 that can be utilized in the processing of subroutine 330, as described below.

The subroutine of FIG. 7 is initiated and passes onto step 331. In step 331, the RAC interfaces with the user to select a lawn section to be processed. For example, the lawn section could be identified using an address of a property, a unique identifier, and/or some other identifier. Then, the process passes onto step 332.

In step 332, the RAC 110 interfaces with the user to select candidate ingredients. Illustratively, candidate ingredients could be sulfur and fertilizer. Then, the process passes onto step 333. In step 333, the RAC 110 interfaces with user to select impact factors to be considered. For example, the impact factors might include manufacturing factors, shipping factors, application factors related to the application or physical application of an ingredient upon the physical location, and/or other factors. Then, the process passes onto step 334.

In step 334, the RAC 110 interfaces with user to select weighting factors for each impact factor. That is, a weighting factor can be entered by the user for each of the impact factors selected in step 333. FIG. 13 shows a GUI 521 that can be used to perform the processing of steps 333 and 334, including the RAC 110 interfacing with the user.

After step 334, the process passes onto step 335. In step 335, the RAC 110 interfaces with user to select a weighting factor for a lawn runoff score. Further details are described below. Then, in step 336, the RAC 110 saves the selected parameters in a database, such as in runoff assessment database 124. Then, in step 337, the RAC 110 outputs a communication to the user that the selected parameters have been successfully saved. Then, in step 338, the subroutine is terminated.

FIG. 8 is a flowchart showing details of “RAC performs processing to perform ingredient determination of PARO processing, so as to determine what ingredient to recommend” of subroutine 350, in accordance with principles of the disclosed subject matter. Subroutine 350 can be called from the processing of FIG. 4.

The process is initiated and passes to step 351. In step 351, the RAC determines what ingredients should be considered as candidate ingredients for application on the lawn section. For example, sulfur and fertilizer might be the two candidate ingredients. Then, in step 352, the RAC 110 assigns the first candidate ingredient as the current candidate ingredient. The process then passes to step 353. In step 353, the RAC 110 determines the weighted_total score for current candidate ingredient. More generally, the RAC 110 determines a score by which the ingredient can be compared against other candidate ingredients. As reflected at 353′, each candidate ingredient is processed to determine a corresponding weighted_total score, for each ingredient

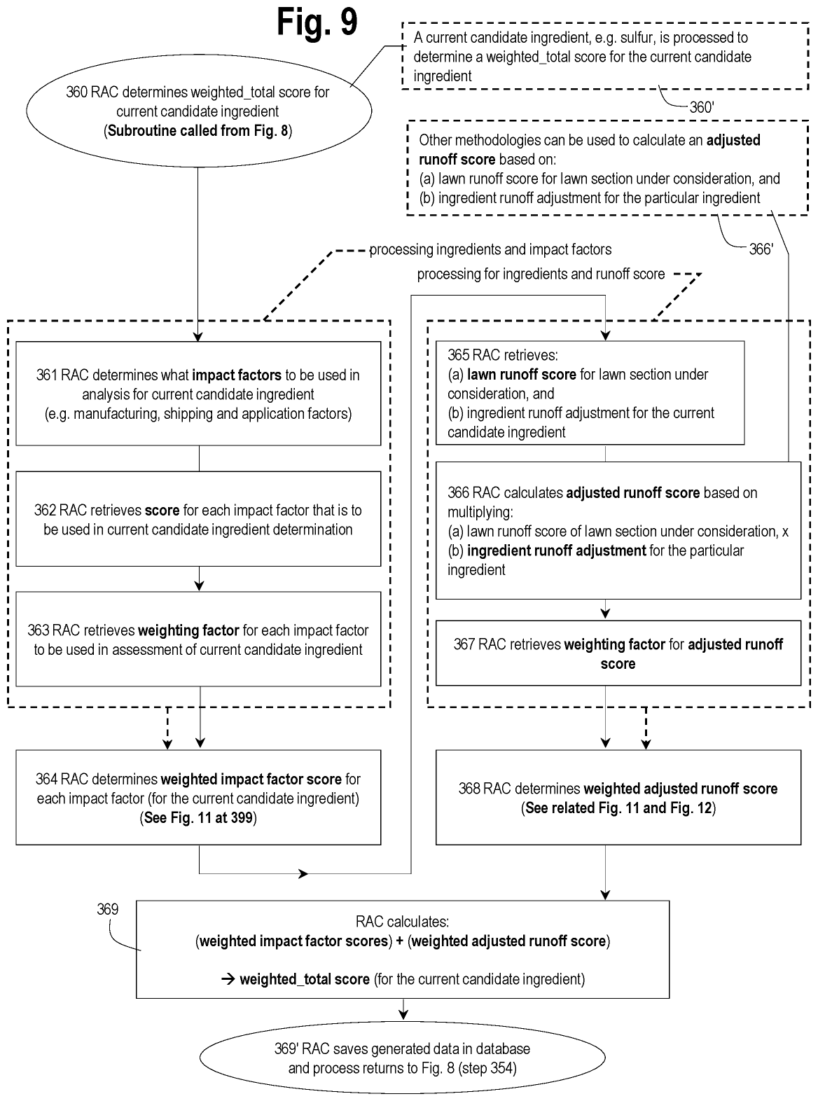

The process of step 353 can be performed by subroutine 360. Further details of subroutine 360 are described below with reference to FIG. 9. After step 353, the process passes onto step 354.

In step 354, the RAC 110 determines if there are any further candidate ingredients. If a yes is rendered, i.e., there is a further candidate ingredient to process, then the process passes onto step 355. In step 355, the RAC 110 assigns the further candidate ingredient to be the current candidate ingredient. Then, processing passes back to step 353, in which the further candidate ingredient will also receive a score. Processing continues as described above.

At a point, there will be no further candidate ingredients. Accordingly, a no will be rendered in the determination step of step 354. Accordingly, the process can pass onto step 356. In step 356, the RAC 110 determines which candidate ingredient has the highest weighted_total score.

Then, in step 357, the RAC 110 tags the candidate ingredient with the highest weighted_total score as the selected candidate ingredient. Then, the process passes on to step 357′, as shown in FIG. 8. In step 357′, the RAC 110 identifies possible application times, sensitivity to weather events of the selected candidate ingredient, and possible upcoming weather events that might effect application of the selected candidate ingredient. Accordingly, the RAC 110 can provide a variety of information and data that can effect application of the selected candidate ingredient. For example, application of a particular ingredient might be desired in a particular time window, such as in the fall season. The RAC 110 can provide data regarding potential application times of an ingredient based on season or other time period or time window. Relatedly, the RAC 110 can identify possible weather events that could affect application of an ingredient in a particular time window. Accordingly, the system can recommend a different application timing based on weather. For example, the system might output a communication to the user or technician “wait until tomorrow to apply fertilizer because heavy rain is forecasted tonight” or some other equivalent communication. In general, the RAC 110 can identify that favorable or unfavorable weather is predicted over some period of time and output related helpful communications to the user or technician. For example, the RAC 110 can access suitable databases, such as weather resources and data 34 shown in FIG. 1, to identify that bad weather is predicted over the next week (or other time period)—and send a communication suggesting that an ingredient be applied after or before such period of bad weather. Also, the RAC 110 can provide information regarding sensitivity of an ingredient to rain or other weather events. For example, some ingredients could be very sensitive to weather events. On the other hand, other ingredients may not be sensitive to weather events. After step 357′, the process passes onto step 358, as shown in FIG. 8.

Then in step 358, the RAC 110 outputs the selected candidate ingredient to the application database for further processing. For example, such further processing might include providing the ingredient information to a lawn technician for application to the physical lawn or other location, ordering the ingredient or making the ingredient available at the location, providing information to a residential owner for application at the location, or other processing or action which can be described as applying the determination of the selected candidate ingredient to an operation for the lawn or other area. A recommendation can be output to a user (such as to a lawn technician or a home owner) as a single event. Recommendations can be output to a user (such as to a lawn technician or a home owner) on a routine or periodic basis, in a routine manner. That is, the processing as described herein, such as in FIG. 8, can be performed on a routine or periodic basis so as to provide updated assessment as additional data is available. After step 358, the process passes onto step 359. In step 359, the process ends. In accordance with principles of the disclosed subject matter, the processing of the disclosure may determine that a particular fertilizer is favored over other fertilizers, and that a particular weed-killer is favored over other weed-killers. Accordingly, the processing of the disclosure can include recommending a blend of the favored fertilizer in combination with the favored weed-killer.

FIG. 9 is a flowchart showing details of “RAC determines weighted_total score for current candidate ingredient” of subroutine 360, in accordance with principles of the disclosed subject matter. Subroutine 360 can be called from the processing of FIG. 8. In the processing of FIG. 9, as noted at 360′, a current candidate ingredient, e.g., sulfur, is processed to determine a weighted_total score for the current candidate ingredient. As described below, steps 361-364 perform processing related to candidate ingredients and impact factors. Steps 365-368 perform processing related to the candidate ingredient and runoff score. The processing of steps 361-364 and steps 365-368 could be performed with serial processing as shown, i.e., in serial manner as shown. The processing of steps 361-364 and steps 365-368 could be performed in parallel manner with parallel processing.

The processing of FIG. 9 is initiated and passes to step 361. In step 361, the RAC determines what impact factors to be used in analysis for current candidate ingredient, such as, e.g., manufacturing, shipping and application factors. Then, the process passes to step 362. In step 362, the RAC retrieves a respective score for each impact factor that is to be used in current candidate ingredient determination.

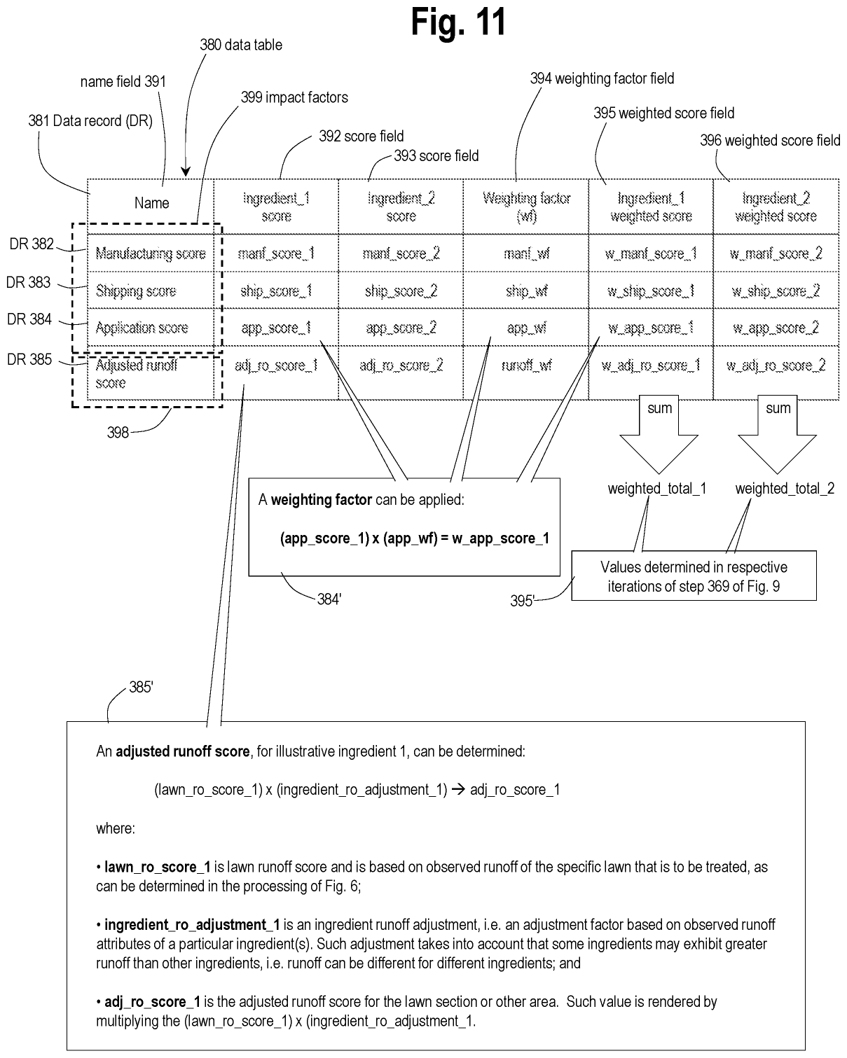

Then, the process passes to step 363. In step 363 RAC retrieves a respective weighting factor for each impact factor to be used in assessment of current candidate ingredient. Then, the process passes to step 364. In step 364, the RAC determines the weighted impact factor score for each impact factor (for the current candidate ingredient). FIG. 11, described below, shows related features. Accordingly, with the conclusion of step 364, the weighted impact factor score for each ingredient has been determined.

After step 364, the process passes to step 365. In step 365 RAC retrieves: (a) lawn runoff score for the lawn section under consideration, and (b) the ingredient runoff adjustment for the current candidate ingredient.

Then, the process passes to step 366. In step 366, the RAC calculates an adjusted runoff score based on multiplying: (a) lawn runoff score for lawn section under consideration, and (b) ingredient runoff adjustment for the particular ingredient. That is, an ingredient runoff adjustment is provided, for each ingredient, in that different ingredients can possess different attributes with regard to runoff. In particular, some ingredients will runoff more than other ingredients.

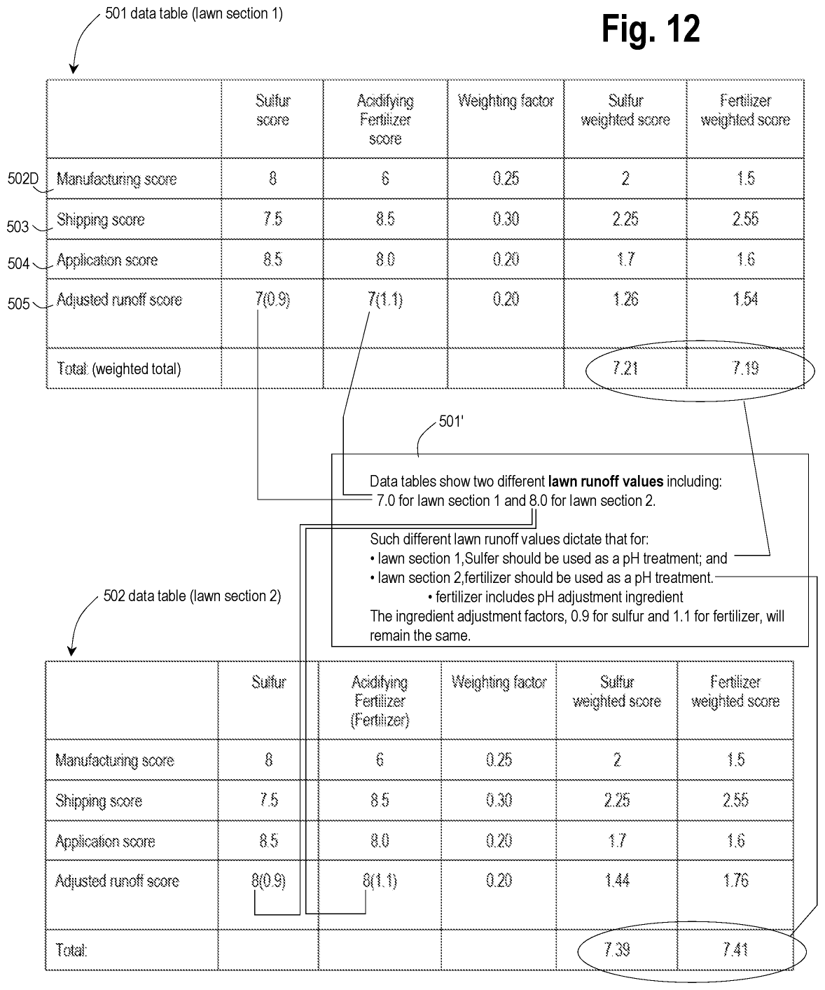

Then, the process passes to step 367. In step 367 RAC retrieves a weighting factor for the adjusted runoff score, i.e., how much weight will be accorded to the value determined in step 366. Then, the process passes onto step 368. In step 368, the RAC determines a weighted adjusted runoff score. Related features are described below with reference to FIG. 11 and FIG. 12. Then, the process passes to step 369.

In step 369, the RAC calculates a summation of: (weighted impact factor scores)+(weighted adjusted runoff score). Such processing renders a weighted_total score (for the current candidate ingredient). Then, the process to step 369′. In step 369′, RAC saves the generated data in database and the process returns to FIG. 8 (step 354).

As described above, the RAC then determines if there is a further candidate ingredient. If the processing (of FIG. 8) determines that there is another candidate ingredient, such another candidate ingredient can also be processed using the processing of FIG. 9.

As noted at 366′, other methodologies can be used to calculate an adjusted runoff score based on: (a) lawn runoff score for the lawn section under consideration, and (b) ingredient runoff adjustment for the particular ingredient.

FIG. 10 is a schematic diagram showing analysis of a lot map 370. As shown in FIG. 10, the lot map 370 shows a property 371, which can also be described as a location, for example. The property 371 can include a first lawn section (lawn section 1) 373, which can be described as an area or geographical area. The property 371 can also include a second lawn section (lawn section 2) 375, which can be described as an area or geographical area. For purposes of illustration, the property 371 can also include a house 372. For example, the lawn section 373 is shown as positioned in the front of the house, whereas the lawn section 375 is shown as positioned in the back of the house or the backyard of the house.

The lawn sections can be described as lawn areas or areas. The lawn sections can be provided with suitable sensors so as to determine attributes of each of the lawn sections. The lawn sections could be provided with multiple sensors so as to determine any variance in attributes across or in different parts of each lawn section. The lawn sections can be chosen and demarcated so as to include portions of a lawn that have similar attributes, such that it may be reasonably assumed that attributes observed in one part of a lawn section would be representative of attributes observed in other parts of the lawn section. For example, a part of the lawn with the same grade could be demarcated as a lawn section.

As shown in FIG. 10, the lawn section 375 can be provided with a sensor 376. The lawn section 373 can be provided with a sensor 374. In this illustrative example, the sensors 374, 376 include a pH meter. However, it is appreciated that processing similar to the processing for the pH meter 374, 376 can be applied to other sensed attributes.

FIG. 10 shows illustrative analysis of parameters at 370′, in accordance with principles of the disclosed subject matter. The lawn section 1 (373) is, for purposes of illustration, 40′×25′ (1,000 square feet). In this example, a pH reading has been observed in lawn section 1, by pH meter 374. The observed pH in the lawn section is 7.5. In this example, the desired pH is 6.5.

For an application to the lawn section 1, the RAC 110 determined that, given soil type, 20 pounds of sulfur should be added to attain the desired 6.5 pH. As a result of such determination by the RAC 110, 20 pounds of sulfur has been physically applied to the lawn section 1. For example, such application may have occurred in October 2021. As a result of data input from the pH meter 374, it was observed that, after 48 hours, the observed pH is (pH=6.8), i.e., a drop in pH of 0.7, indicating that desired pH was not obtained. Accordingly, a runoff conclusion from such observation is that the desired pH change was 1.0, but only a pH change of 0.7 was observed, i.e., 70% of desired change was observed. Accordingly, in this illustrative processing, the RAC 110 concludes that only 70% of the applied sulfur was retained. Based on this observed data (70% of the applied sulfur being retained), a lawn runoff score is assigned to the lawn section 1 (373). That is, the lawn runoff score, for the particular section of lawn, is 7. It is appreciated that other methodologies or schemes for determining and representing a runoff score can be used.

Relatedly, FIG. 11 is a schematic diagram showing a data table 380, in accordance with principles of the disclosed subject matter. The data table 380 includes a plurality of data records DR 382, DR 383, DR 384, DR 385. Each of the data records includes a plurality of fields 391, 392, 393, 394, 395, 396. A name field 391 contains a name or identification of a factor to be considered in the runoff assessment processing described herein, in the determination of a suitable ingredient to be applied to a location. For example, the factors can include manufacturing score, shipping score, application score, and adjusted runoff score. The manufacturing score can provide a score or rating with regard to manufacturing attributes of an ingredient. For example, if a manufacturing score is low, such might indicate that the ingredient is difficult or expensive to manufacture. If a manufacturing score is high, such might indicate that the ingredient is easy or inexpensive to manufacture. The manufacturing score can take into account carbon emission considerations, pollution considerations, and various other considerations.

The shipping score can provide a score or rating with regard to shipping attributes of an ingredient. For example, if a shipping score is high, such might reflect that the ingredient is easy or inexpensive to ship. The shipping score can take into account a total process of shipping from supplier to home, for example.

The application score can provide a score or rating with regard to application attributes of the ingredient. For example, such score may go to whether an ingredient is easy or difficult to apply to a location. Such application score might also represent whether an ingredient is inexpensive or expensive to apply to a location.

It should be appreciated that the manufacturing score, shipping score, and application score shown in FIG. 11 are only representative. There may be innumerable factors that may also be considered in the processing of the disclosure. Also, the factors that are shown in FIG. 11 may be broken out into further factors or sub-factors. For example, the manufacturing score may be broken out into a material cost of manufacturing score and a labor cost of manufacturing score. Accordingly, the processing of the disclosure allows for a wide variety of factors to be taken into account in the determination of what ingredient to apply to a location. As more factors are added to the processing, for consideration, more data records can be added to the data table 380.

Illustratively, a liquid fertilizer could be inexpensive to manufacture in a concentrated form and thus receive a relatively high manufacturing score. However, the liquid fertilizer might receive a lower application score as compared to a fertilizer that does not need mixing with water. Accordingly, the disclosure provides a mechanism by which to assess a wide variety of attributes and considerations in the determination of a best ingredient to apply to a lawn or other location.

It is appreciated that various arrangements or rating schemes can be utilized in practice of the disclosure. For example, in some embodiments, a low score may be more favorable than a high score. In other embodiments, a high score may be more favorable than a low score. In some embodiments, a 1 score might be the lowest score, where as a 10 might be the high score. Other mechanisms can be utilized. For example, a rating scheme can be used in which a “1” value is an average rating, whereas 0.8 is below average, and 1.2 is above average. That is, a drop below 1 is indicative of a poor rating, whereas an increase over 1 is indicative of a favorable rating. Other schemes or arrangements can be utilized.

The data table 380 also includes a data record 385 which is populated by “adjusted runoff score” value in the name field 391. Such data record 385 contains various data regarding an adjusted runoff score of the location under consideration. Field 392 in data record 385 can be described as a runoff factor 398, as shown in FIG. 11. Also, the manufacturing score, shipping score, and application score can be described as impact factors 399, as shown in FIG. 11. Accordingly, the runoff factor 398 and the impact factors 399 can be described as factors in the processing of the disclosure.

The data table 380 can be described as including first data regarding a first candidate ingredient to be considered for application to the location; second data regarding a second candidate ingredient to be considered for application to the location; and third data regarding a runoff score for the location. The data in data table 380

For each data record, the data table 390 includes a score field 392. The score field 392 contains a score, for a first ingredient, for each factor listed in data field (name field) 391. Illustrative values are shown in the data tables of FIG. 12. For example, the first ingredient, i.e., ingredient_1, might be sulfur.

For each data record, the data table 390 includes a score field 393. The score field 393 contains a score, for a second ingredient, for each factor listed in data field (name field) 391. Illustrative values are shown in the data tables of FIG. 12. For example, the second ingredient, i.e., ingredient_2, might be an acidifying fertilizer or fertilizer.

For each data record, the data table 390 includes a weighting factor field 394. The weighting factor field 394 contains a weight, for each factor listed in data field 391. Illustrative values are shown in the data tables of FIG. 12.

For each data record (i.e., for each factor), the data table 390 can include an ingredient_1 weighted score field 395. The ingredient_1 weighted score field 395 contains a weighted score for ingredient 1, for each factor listed in data field 391. Such value in field 395 can be determined (by the RAC 110) by multiplying the score field value in field 392 by the weighting factor in field 394, so as to render a weighted score for ingredient 1. That is, e.g., with regard to data record 384, a weighting factor can be applied as noted at 384′, with regard to the “application score.” Illustrative values are shown in the data tables of FIG. 12. Such processing corresponds (for each impact factor 399) to the processing of step 364 (FIG. 9), and (for the adjusted runoff factor 398) to the processing of step 368 (of FIG. 9).

For each data record (i.e., for each factor), the data table 390 can include an ingredient_2 weighted score field 396. The ingredient_2 weighted score field 396 contains a weighted score for ingredient 2, for each factor listed in data field 391. Such value in field 396 can be determined (by the RAC 110) by multiplying the score field value in field 393 by the weighting factor in field 394, so as to render a weighted score for ingredient 1. Illustrative values are shown in the data tables of FIG. 12. Such processing corresponds (for each impact factor 399) to the processing of step 364 (FIG. 9), and (for the adjusted runoff factor 398) to the processing of step 368 (of FIG. 9).

Then, the weighted score for each ingredient can be summed as noted at 395′ of FIG. 11. Such processing corresponds to the processing of step 369 in FIG. 9. That is, a weighted total score can be determined (for each candidate ingredient) by respective iterations of the processing of FIG. 9. In accordance with an embodiment, the ingredient that renders the highest weighted total score can be deemed the selected candidate ingredient, of the candidate ingredients listed in data table 380, in FIG. 11.

As described above, the data table 380 includes a data record 385 which is populated by “adjusted runoff score” value in the name field 391. As noted at 385′ in FIG. 11, an adjusted runoff score, for illustrative ingredient 1, can be determined by:

(lawn_ro_score_1)×(ingredient_ro_adjustment_1)→adj_ro_score_1

where:
lawn_ro_score_1 is lawn runoff score and is based on observed runoff of the specific lawn that is to be treated, as can be determined in the processing of FIG. 6;
ingredient_ro_adjustment_1 is an ingredient runoff adjustment, i.e., an adjustment factor based on observed runoff attributes of a particular ingredient(s). Such adjustment takes into account that some ingredients may exhibit greater runoff than other ingredients, i.e., runoff can be different for different ingredients; and
adj_ro_score_1 is the adjusted runoff score for the lawn section or other area. Such value is rendered by multiplying the (lawn_ro_score_1)×(ingredient_ro_adjustment_1.

However, in accordance with at least one embodiment of the disclosed subject matter, the processing performed by the RAC 110 may not adjust runoff score based on the particular ingredient. For example, the variance in runoff between ingredients under consideration may be similar in value. As a result, the additional processing bandwidth, to process for adjusted runoff score, may not be warranted.

It is appreciated that various processing described herein describes the assessment of particular mathematical relationships between values. It is appreciated that other mathematical relationships could be used in the processing of the disclosure. That is, other mathematical relationships, mathematical schemes, or mathematical mechanisms can be used so as to assess relationships between various values under consideration. For example, subtraction, addition, division, multiplication, the differential of a value from a standard value, the differential of a value from a norm, a logarithmic relationship, an exponential relationship, and/or other mathematical relationships or mechanisms can be used so as to assess relationships between different values under consideration.

As described herein, a weighting factor can be described as a weight given to a value or data point to assign such value or data point a greater, or lesser, importance in a group or collection of similar data values or data points.

FIG. 12 is a diagram showing data tables 501 and 502, in accordance with principles of the disclosed subject matter. The data tables 501 and 502 are populated with data and are respective instances of the data table 380 of FIG. 11.

As shown in FIG. 11, the data table 501 relates to assessing whether sulfur or acidifying fertilizer (fertilizer) should be applied to lawn section 1 of the property 371 shown in FIG. 10. Accordingly, in manner similar to the data table 380 of FIG. 11, the data table 501 includes a manufacturing score data record 502D, a shipping score data record 503, and an application score data record 504. Each of such impact factors have a respective score for sulfur and fertilizer, as shown in FIG. 12. For example, the manufacturing score for sulfur is 8 and the manufacturing score for fertilizer is 6.

Data table 501, as noted at 501′, illustratively shows a lawn runoff value of 7.0. The lawn runoff value can be determined from the processing of FIG. 7 and is independent of ingredient, here sulfur and fertilizer. However, as discussed above, the lawn runoff value can be modulated using a ingredient adjustment factor. As shown in data table 501, the ingredient adjustment factor is 0.9 for sulfur and 1.1 for fertilizer. Accordingly, an adjusted runoff score is (7×0.9) for sulfur, and an adjusted runoff score is (7×1.1) for fertilizer. The higher score for fertilizer can reflect that the fertilizer has somewhat better or more favorable runoff attributes. For example, the fertilizer may resist absorption by flowing water better than sulfur, or have other traits that provide better runoff attributes.

As shown in data table 501 of FIG. 12, for lawn section 1, each of the factors listed are associated with a weighting factor, as described above with reference to FIG. 11. Based on the score of each factor and associated weighting factor, a sulfur weighted score can be determined and a fertilizer weighted score can be determined as shown in FIG. 12. Illustratively, the scores for sulfur are 2, 2.25, 1.7, and 1.26—thus resulting in a weighted total score of 7.21. Illustratively, the scores for fertilizer are 1.5, 2.55, 1.6, and 1.54—thus resulting in a weighted total score of 7.19. Accordingly, sulfur is the preferred ingredient to apply to lawn section 1. Illustratively, the processing of data table 501 might relate to the determination of a best ingredient for adjusting pH of the lawn section 1.

Data table 502 is of similar architecture and arrangement to data table 501. Data table 502 relates to lawn section 2 of the property 371 shown in FIG. 10. However, lawn section 2 has a different runoff value as compared to lawn section 1.

More specifically, data tables 501, 502 show two different lawn runoff values including: 7.0 for lawn section 1 and 8.0 for lawn section 2. As shown in FIG. 12, in this illustrative example, the ingredient adjustment factors, 0.9 for sulfur and 1.1 for fertilizer, will remain the same. That is, in this example, the ingredient adjustment factors is dependent on the particular ingredient, and not dependent on the attributes of the lawn (to which the ingredient will be applied). On the other hand, the runoff score of 7 (for lawn section 1) and 8 (for lawn section 2) is dependent on the attributes of the particular lawn section, in this example.

Accordingly, as illustrated by the example of FIG. 12, with a lawn runoff score of 7 for lawn section 1, the weighted total for sulfur is 7.21 versus the weighted total for fertilizer is 7.19. Accordingly, sulfur would be favored for application to lawn section 1, as a pH treatment, for example.

However, with a lawn runoff score of 8 for lawn section 2, the weighted total for sulfur is 1.44 and the weighted total for fertilizer is 1.76. Accordingly, fertilizer would be favored for application to the lawn, as a pH treatment, for example. It can thus be seen that with an increase of lawn runoff score, a different ingredient can become favored for application to a lawn section or other area.

FIG. 13 is a schematic diagram of a user device 130 displaying a graphical user interface (GUI) 521, in accordance with principles of the disclosed subject matter. The GUI 521 can be provided to interface with the user to input various information from the user, to perform post-application runoff processing.

The GUI 521 can include a text field 531 by which a user can input an address for the service. Relatedly, a text field 532 can be used to input the identification of a lawn section or other area for service. Accordingly, a single address can have different sections or lawn sections that are treated differently. Such multiple sections of a lawn are illustrated in FIG. 10.

The GUI 521 also includes window 540. The window 540 is provided so that the user can specify ingredients to be considered for possible application to the lawn section. As shown, field 541 lists fertilizer and field 542 lists sulfur. The window 540 can be populated with prior ingredients that were used by the user in the particular lawn section or area. Also, the window 540 could be automatically populated so as to present ingredient options to the user. The window 540 also includes selection boxes 541′ and 542′ by which a user can select or deselect a particular ingredient for consideration. Button 543 can be provided on the GUI 541 to allow a user to add an additional ingredient for consideration. Accordingly, window 540 provides functionality by which the RAC 110 can interface with a user to specify ingredients to be considered for a desired application. In the illustrative examples provided herein, sulfur and fertilizer are described as ingredients that can be processed by the system of the disclosure for possible application to a lawn section or other area for service. However, it is appreciated that any of a wide variety of materials can be processed by the system of the disclosure. For example, nitrogen fertilizers and phosphorus fertilizers can be ingredients that are processed as candidate ingredients for possible application to a lawn section.

The GUI 521 also includes window 545. The window 545 presents “impact factors” that the user can select or deselect using selection boxes 546′, 547′ and 548′. Such selection boxes correspond to selection or de-selection of manufacturing considerations, shipping considerations, and application considerations, respectively. In other embodiments, additional impact factors could be presented to the user. As shown in GUI 521, each impact factor is associated with a weighting option. The weighting option allows the user to select how much weight should be accorded to a particular impact factor. The user can select a weight to be accorded to an impact factor using option fields 546, 547 and 548. In this example, manufacturing has been accorded a weight of 0.25; shipping has been accorded a weight of 0.30; and application has been accorded a weight of 0.20. Such weighting corresponds to the example presented in FIG. 12, as described above.

Additionally, the GUI 521 includes window 550. The window 550 allows a user to select how much weight should be accorded to lawn runoff. The user can select a desired weighting using option field 551. In this example, 0.2 has been selected by the user is the weighting to accord to lawn runoff. Such corresponds to the illustrative example presented in FIG. 12. As shown in window 550, a communication can be presented to the user indicating “Lawn runoff weighting determines how much weight will be accorded to lawn runoff (process will also take into account runoff attributes of each ingredient)”.

The window 550, of GUI 521, also includes item 553. Item 553 provides an indication that “lawn runoff for this section of lawn has been previously determined”. A box 554 can be checked so as to convey that lawn runoff for the section has been determined. Item 553 is indicative that the processing of FIG. 5, described above, has been performed. That is, an application of material or other ingredient has been applied to the particular lawn section and runoff attributes of such application of ingredient have been determined. In the case that lawn runoff has not been determined for the particular lawn section, then an alternative communication could be output to the user via window 550. For example, such alternative communication could convey that the current application of ingredient is indeed the first application of ingredient to the lawn section. As a result, the RAC 110 conveys that post-application runoff processing (PARO) processing cannot be performed at this time. The RAC 110 can also convey to the user that after this current application of ingredient, data will be input so as to allow post-application runoff processing in the future.

The GUI 521 also includes item 560. Item 560 provides functionality by which the user can name and save the profile, which has been created using the GUI 521. In this example, the user has opted to save the profile created using the GUI 521 as Spring_pH treatment_123. For example, such data can be saved in the location database 123, as shown in FIG. 3.

The user device 130 can include known features, such as a speaker 523, a camera 522, a microphone 524, menu options 525, and other known features.

FIG. 14 is a flowchart showing details of processing in which the RAC 110 determines runoff score based on a model, of subroutine 600 as called from the processing of FIG. 5. Subroutine 600 is initiated and passes onto step 601.

In step 601, the RAC 110 interfaces with a user so as to select a target lawn section (TLS) to be processed by the runoff modeling portion 118, as shown in FIG. 3. For example, the TLS could be selected from a listing or drop-down menu of possible lawn sections, so as to be selectable by the user. The TLS could be identified or labeled based on a unique identifier. After step 601, the processing passes onto step 603. In step 603, the RAC 110 inputs or accesses attributes of the TLS. In such processing, a wide variety of attributes, i.e., properties, can be accessed. As illustratively shown in step 603, such attributes can include slope of lawn section; density of soil; pH of soil; type of grass and/or grass mix; thickness of lawn (on scale: 1=sparse; 10=very dense); observed weed density (on scale: 1=many weeds; 10=no weeds); and/or other attributes. The values of such attributes can be based on average values in the TLS. For example, the slope of such lawn section can be based on an average slope over the area of the particular lawn section. Then, the process passes onto step 604.

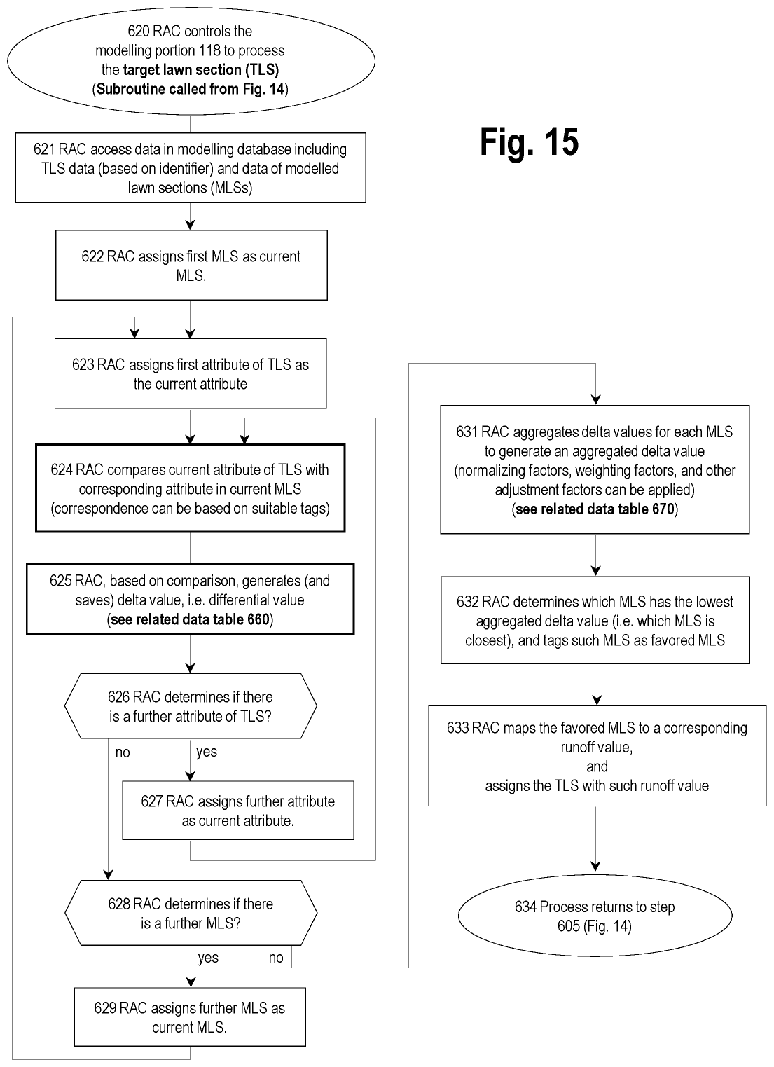

In step 604, the RAC 110 controls the runoff modeling portion 118, i.e., the modeling portion 118, to process the target lawn section. Such processing can be performed by subroutine 620 as described below with reference to FIG. 15. Then, the process passes onto step 605. In step 605, the RAC 110 identifies that a runoff score has been determined by the modeling portion 118. Then, in step 606, the RAC 110 saves the runoff score in a suitable database, such as in the runoff assessment database 124, shown in FIG. 3. As reflected at 606′, step 606 relates to the processing of step 328 (FIG. 6) in which the RAC 110 saves a runoff score. That is, the runoff score saved in step 328 is illustratively determined from observation of the particular lawn section itself. On the other hand, the runoff score saved in step 606 is determined from comparison, by modeling portion 118, of attributes of the TLS versus data in a runoff modeling database 128.

After step 606 of FIG. 14, the processing passes on to step 607. In step 607, the processing of subroutine ends with a lawn runoff score, for the target lawn section, having been determined.

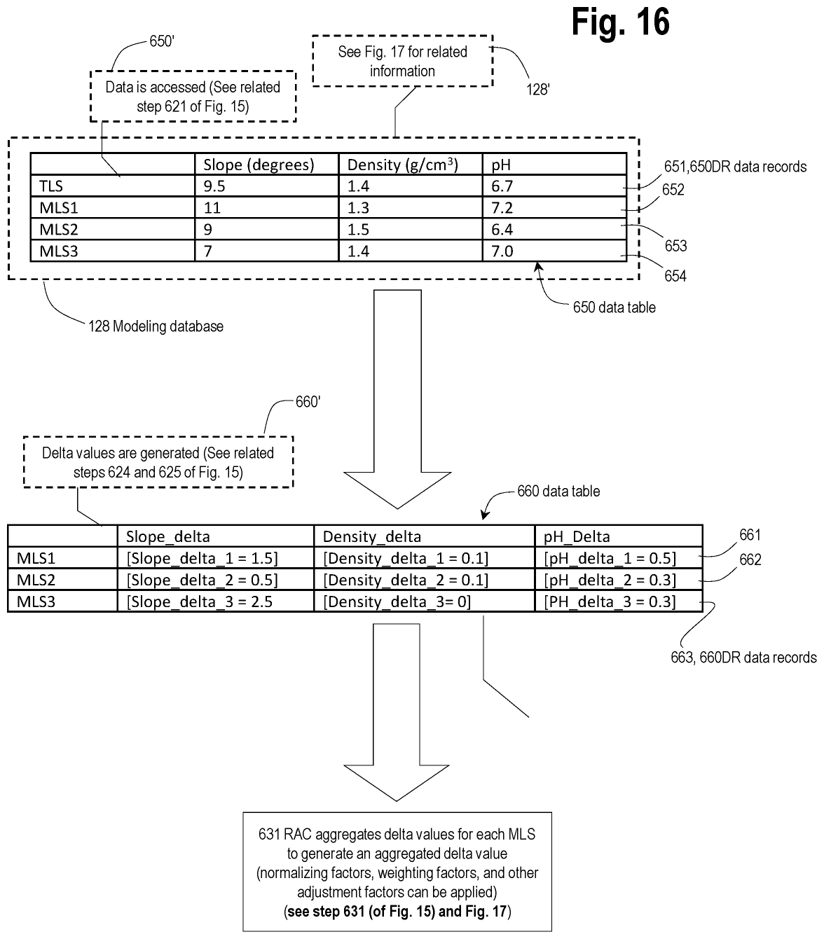

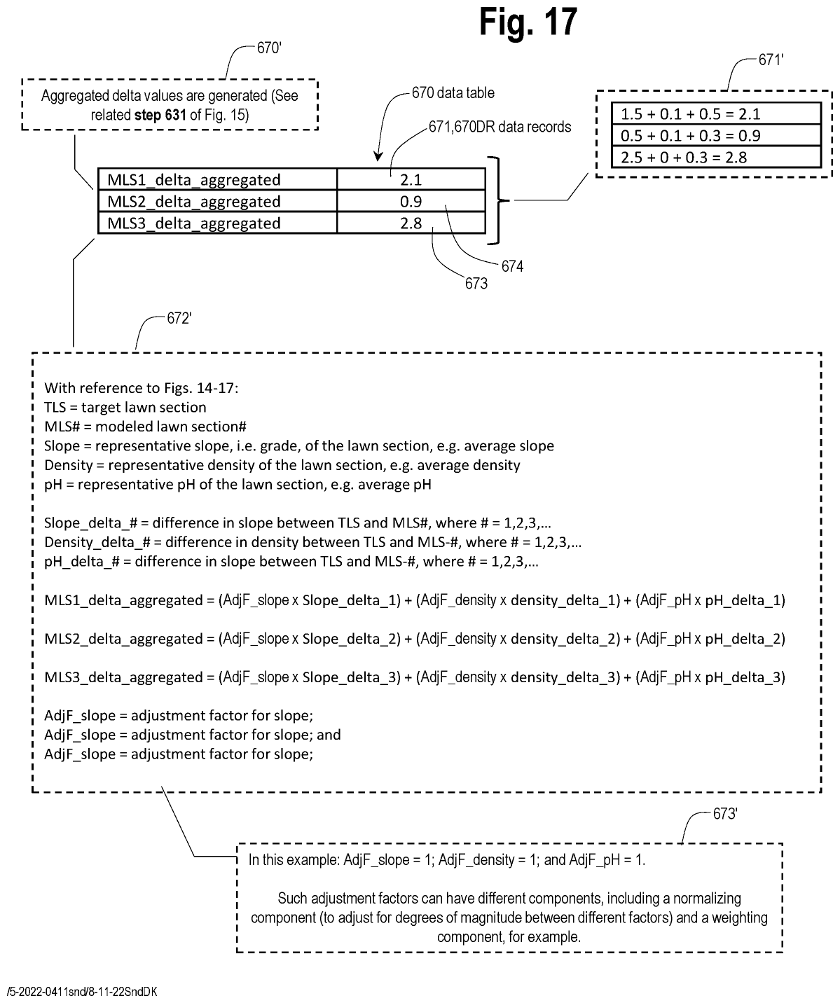

FIG. 15 is a flowchart showing details of processing in which the RAC 110 controls the modeling portion 118 to process the target lawn section (TLS), of subroutine 620 as called from the processing of FIG. 14. The subroutine is initiated and passes onto step 621. In step 621, the RAC 110 accesses data in the modeling database 128. The data accessed can include target lawn section data, which can be accessed based on an identifier of the lawn section. The data accessed can also include data of modeled lawn sections (MLSs). Such data, of the modeling database 128, is illustratively shown in FIG. 16. That is, FIG. 16 is a schematic diagram showing aspects of data processing in an illustrative modeling process. FIG. 16 shows data table 650. As noted at 650′ in FIG. 16, the data of the data table 650 can be accessed in the processing of step 621 of FIG. 15. As reflected at 128′ of FIG. 16, information related to the processing of FIG. 15 and FIG. 16 is illustrated in FIG. 17 (at 672′), including information regarding variables used in the described processing.

As shown in FIG. 16, the data table 650 can include a plurality of data records 650DR. The data records 650DR can include data records 651, 652, 653, 654. The data record 651 can include attributes of the target lawn section (TLS). More specifically, the data record 651 can include slope, density, and pH attributes of the target lawn section, in this illustrative example. Such processing is illustrative and various other attributes can also be considered. The data record 652 can include slope, density, and pH attributes of a modeled lawn section 1, i.e., a first modeled lawn section. In similar manner, data record 653 and 654 can include data regarding additional modeled lawn sections, i.e., second and third modeled lawn sections. It is appreciated that while only three modeled lawn sections are shown in data table 650, the data table 650 can include many modeled lawn sections, which can be accessed for comparison to the target lawn section.

With further reference to FIG. 15, after step 621, the processing passes onto step 622. In step 622, the RAC 110 proceeds with processing in which each modeled lawn section represented in data table 650 is compared to the target lawn section, based on respective attributes. Accordingly, in step 622, the RAC 110 assigns a first modeled lawn section (MLS) as a current MLS. For example, the first MLS can be a MLS1, as represented in data record 652 of data table 650. Then, the processing passes onto step 623. In step 623, the RAC 110 assigns a first attribute of the target lawn section (TLS) as the current attribute. Then, in step 624, the RAC 110 compares the current attribute of the TLS with a corresponding attribute in the current MLS. For example, correspondence can be based on suitable tags associated with data of the TLS and the MLS. Accordingly, in step 624, the first attribute (e.g., slope) of the TLS can be compared to the slope attribute of MLS1. Such comparison is performed so as to determine a degree of correspondence between the target lawn section in the particular modeled lawn section. As reflected at 660′ of FIG. 16, delta values, i.e., differential values, can be generated so as to represent a delta or difference (in value) between an attribute of the target lawn section and a corresponding attribute of a modeled lawn section. Accordingly, FIG. 16 shows data table 660 that can include a plurality of data records 660DR. The data records 660DR can include data record 661, 662, 663. Prior to being populated with delta data, the data table 660 can be empty or null. Accordingly, the population of data table 660 represents a transformation of data, in the processing of the disclosure.

After the processing of step 624 in FIG. 15, the process passes on to step 625. In step 625, the RAC 110, based on the comparison of step 624, generates (and saves) a delta value based on the comparison of attributes of the target lawn section and the current MLS. Illustratively, data table 650 shows that the TLS has a slope of 9.5°. MLS1, i.e., the current MLS, has a slope of 11°. Accordingly, a delta or differential between such values is 1.5—as is saved for (the value of) the Slope_delta_1 variable, in data record 661 of data table 660. In this illustrative processing, the RAC 110 determines an absolute value difference between attribute value of the TLS an attribute value of a particular MLS. That is, such determination of absolute value between the value of attributes does not take into account whether an attribute of the TLS is greater than or less than a corresponding attribute of an MLS. However, such positive or negative relationship between attributes could be taken into account the more complex processing.

After step 625, the process passes onto step 626. In step 626, the RAC 110 determines if there is a further attribute of the TLS to process. If yes, then the process passes onto step 627. In step 627, the RAC 110 assigns the further attribute as the current attribute of the TLS. Then, the process passes back to step 624. Processing then continues as described above. In this example, such iterative processing can be utilized to compare the density of the TLS with the density of the first modeled lawn section, i.e., MLS1. Then, in a further iteration (of step 624), the pH value of the TLS can be compared with the pH value of MLS1.

At a point in such processing, the RAC 110 will have compared each attribute of the TLS with a corresponding attribute of the first modeled lawn section, i.e., MLS1. Then, the processing passes onto step 628. In step 628, the RAC 110 determines if there is a further MLS to compare with the TLS. If yes, then the process passes onto step 629. In step 629, the RAC 110 assigns the further MLS as the current MLS. Processing then passes back to step 623 of FIG. 15. Processing then continues as described above, so as to assess a degree of correspondence between the TLS and such further MLS, i.e., in this example MLS2. As a result, data table 660 (FIG. 16), will be further populated with delta values representing degree of correspondence between the target lawn section and further modeled lawn sections (MLSs). Iterative processing can thus be performed for each modeled lawn section in the modeling database 128. In practical application, there can be many, e.g., hundreds or thousands, of modeled lawn sections.

At a point in the processing, the determination of step 628 will render a no. That is, the RAC 110 will determine that there are no further MLSs to process. Thus, data table 660 will be fully populated, so as to proceed to subsequent processing. That is, if a no is rendered in step 628, the processing passes onto step 631.

In step 631, the RAC 110 aggregates the delta values for each MLS to generate an aggregated delta value (for each MLS). The aggregated delta value, for each MLS, represents the degree of correspondence between each MLS in the target lawn section (TLS). It is appreciated that normalizing factors, weighting factors, another adjustment factors can be applied, as is also described below with reference to FIG. 17.

FIG. 17 is a schematic diagram illustrating further aspects of modeling processing. FIG. 17 shows data table 670 with data records 670DR. The data records 670DR includes data record 671, 672, 673. The data record 671 includes the aggregated deltas for MLS1, as noted at 670′ in FIG. 17. The data record 672 includes the aggregated deltas for MLS2. The data record 673 includes the aggregated deltas for MLS3. The aggregation of delta values is illustrated at 671′ of FIG. 17, which shows the aggregation of corresponding delta values (slope, density, pH, etc.) of data table 660 (FIG. 16) to generate a summed or added value. Such summed value is then used to populate data table 670, shown in FIG. 17.

With further reference to FIG. 15, after step 631, the process passes onto step 632. In step 632, the RAC 110 determines which MLS has the lowest aggregated delta value. Such lowest aggregated delta value represents which MLS is the closest to the target lawn section attributes. The RAC 110 then tags such MLS as the favorite MLS. As shown in FIG. 17, MLS2 possesses an aggregated delta value of 0.9, which represents that MLS2 is closest in attribute value to the TLS. Accordingly, in this example, MLS2 would be favored. In other words, the RAC 110 can tag the MLS that is most favored in the modeling. Then, the process passes onto step 633.

In step 633, the RAC 110 maps the favored MLS to a corresponding runoff value. That is, the RAC 110 determines the runoff value that corresponds to the favored MLS. The RAC 110 then uses that runoff value as the runoff value for the target lawn section. Then, the process passes onto step 634. In step 634, the process returns to step 605 of FIG. 14. Processing then continues as described above.

As noted at 672′ of FIG. 17, various information regarding the modeling process is illustrated, including information regarding the variables used in such modeling processing. Relatedly, as noted at 673′, adjustment factors can be used in the modeling processing. Such adjustment factors can have different components, including a normalizing component (to adjust for degrees of magnitude between different factors) and a weighting component, for example. The weighting component can be used to control which attribute is considered more heavily. For example, it may be determined that slope should be considered more heavily, and thus weighted more heavily, for applications of a particular ingredient. The adjustment factors (such as AdjF_slope=an adjustment factor for slope) can also include a normalizing component to adjust for degrees of magnitude between different factors. That is, scaling (i.e., units used) of slope in degrees is different versus scaling of density in g/cm³, and thus a normalizing factor can be applied so as to adjust for such different scaling.

As reflected at 673′, in the illustrative processing of FIG. 17, the adjustment factors are assigned a value of 1, for purposes of simplicity and illustration. As a result of the adjustment factors having a value of 1, it is noted that certain attributes may inherently be weighted more heavily, due to the scaling of such attributes.

As disclosed above, a modeling process is described in which attributes of a target lawn section is compared to attributes of modeled lawn sections. Each of such modeled lawn sections are associated with a known runoff value. Such known runoff value (of the modeled lawn sections) may be determined from the processing of FIG. 5 and FIG. 6, as described above. It is appreciated that other modeling techniques and processes can be utilized in addition to the techniques described herein. For example, known machine learning and artificial intelligence (AI) modeling techniques and processes can be utilized to analyze attributes of a target lawn section, compare such known attributes with modeled data points, and determine a runoff value for the target lawn section. Relatedly, it is appreciated that the model of the disclosure can be evolved over time, i.e., trained. For example, an ingredient can be applied to a target lawn section using the modeling processing as described herein. Results of that application can be assessed utilizing the processing of FIGS. 5 and 6. Such observed results can then be used to tweak or train the adjustment factors illustrated at 672′ and 673′ of FIG. 17.

As described herein, various disclosure is provided as relating to a lawn section or lawn. It is appreciated that the systems and methods of the disclosure can be applied to any geographical area or area, as may be desired. In addition, although application of ingredient is described above as one operation that can be recommended or carried out by the system 10 after a runoff condition is determined or predicted, other operations can include mowing of grass before or after runoff conditions are predicted or determined, as well as planting, seeding, watering, etc., before or after runoff conditions are predicted or determined.

Hereinafter, further aspects of the disclosure will be described.

As described herein, in at least some embodiments of the system of the disclosure, various processes are described as being performed by one or more computer processors. Such one or more computer processors can, in conjunction with a database or other data storage mechanism, provide and/or constitute a “processing machine,” i.e., a tangibly embodied machine, in that such one or more computer processors can include various physical computing devices as otherwise described herein, various support structure to physically support the computing devices, other hardware, and other physical structure, for example. In embodiments, a processing machine of the disclosure can include one or more computer processors and one or more databases that are in communication with the one or more computer processors. A computer processor or processing machine of the disclosure can be part of a higher level system or apparatus.

As used herein, the term “computer processor” can be understood to include at least one processor that uses at least one memory. The at least one memory can store a set of instructions. The instructions may be either permanently or temporarily stored in the memory or memories of the processing machine or associated with the processing machine. The computer processor can execute the instructions that are stored in the memory or memories in order to process data, input data, output data, and perform related processing. The set of instructions may include various instructions that perform a particular task or tasks, such as any of the processing as described herein. Such a set of instructions for performing a particular task may be described as a program, software program, code or simply software. Accordingly, various processing is described herein as performed by a computer processor (CP). Such computer processor (CP) can be described as or can include: a computer processor portion, a computer processing portion, a processor, a system processor, a processing system, a server, a server processing portion, an engine, a processing engine, a central processing unit (CPU), a controller, a processor-based controller, an electronic computing device, an apparatus controller, an apparatus computer processor, a processing device, a computer operating system, an apparatus processing portion, an apparatus processing portion, an electronic control unit (“ECU”), a microcontroller, a microcomputer, a plurality of electronic computing devices or servers, other processor-based controller(s), and/or similar constructs, for example.

A computer processor and/or processing machine, of the disclosure, may be constituted by and/or be part of particular apparatus(es), system(s) and/or device(s) described herein. The computer processor can execute instructions that are stored in memory or memories to process data. This processing of data may be in response to commands by a user or users of the computer processor, in response to previous processing, in response to a request by another processing machine and/or any other input, for example. A user can be in the form of a user device, such as a cellular phone.

A computer processor and/or processing machine of the disclosure may also utilize (or be in the form of) any of a wide variety of technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that can be capable of implementing the steps of the processes of the disclosure.

The computer processor and/or processing machine used to implement the disclosure may utilize a suitable operating system. Thus, embodiments of the disclosure may include a processing machine running the Windows 11 operating system, the Windows 10 operating system, the Windows 8 operating system, Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the disclosure as described herein, it is not necessary that the computer processors and/or the memories of a processing machine be physically located in the same geographical place. That is, each of the computer processors and the memories used by the processing machine may be located in geographically distinct locations and connected so as to communicate in any suitable manner. Additionally, it is appreciated that each computer processor and/or the memory may be composed of different physical pieces of equipment. Accordingly, it is not necessary that a processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above can be performed by various components and various memories. However, it is appreciated that the processing performed by two distinct components as described herein may, in accordance with a further embodiment of the disclosure, be performed by a single component. Further, the processing performed by one distinct component as described above may be performed by two distinct components. For example, processing as described herein might be performed in part by a system or other system or server, in part by some third party resource, and in part by a user device. In a similar manner, the memory storage performed by two distinct memory portions as described herein may, in accordance with a further embodiment of the disclosure, be performed by a single memory portion. Further, the memory storage performed by one distinct memory portion as described above may be performed by two memory portions.

Further, as described herein, various technologies may be used to provide communication between the various processors and/or memories, as well as to allow the processors and/or the memories of the disclosure to communicate with any other entity; i.e., so as to obtain further instructions, transfer data, or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described herein, a set of instructions can be used in the processing of the disclosure on the processing machine, for example. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

It is appreciated that the instructions or set of instructions used in the implementation and operation of features of the disclosure may be in a suitable form such that a computer processor or processing machine may read the instructions. For example, the instructions that form a program may be in the form of a suitable programming language, which can be converted to machine language or object code to allow the processor or processors to read the instructions. That is, written lines of programming code or source code, in a particular programming language, can be converted to machine language using a compiler, assembler or interpreter. The machine language can be binary coded machine instructions that are specific to a particular type of processing machine, i.e., to a particular type of computer processor, for example. The computer processor understands the machine language.

Accordingly, a suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, Python, Ruby, PHP, Perl, JavaScript, and/or other scripting language, for example. Further, it is not necessary that a single type of instructions or single programming language be utilized in conjunction with the operation of the systems and methods of the disclosure. Rather, any number of different programming languages may be utilized as may be necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example. Accordingly, a compression or encryption technique or algorithm can be used that transforms the data from an un-encrypted format to an encrypted format.

As described above, the disclosure may illustratively be embodied in the form of a processing machine, including a computer processor, for example, that includes at least one memory. It is to be appreciated that the set of instructions, i.e., the software for example, that enables the computer processor to perform the operations described herein may be contained on any of a wide variety of media or medium, as desired. Further, the data that can be processed by the set of instructions can be contained on any of a wide variety of media or medium. That is, the particular medium, i.e., the memory or data storage device used in a processing machine, utilized to hold the set of instructions and/or the data used in practice of the disclosure may take on any of a variety of physical forms or transmissions, for example. Illustratively, the medium or data storage device may be in a tangibly embodied form of paper, paper transparencies, a compact disk, a DVD, an integrated circuit, a hard disk, a floppy disk, an optical disk, a magnetic tape, a RAM, a ROM, a PROM, a EPROM, a CD-ROM, a DVD-ROM, a hard drive, a magnetic tape cassette, a wire, a cable, a fiber, communications channel, and/or may be in the form of a satellite transmissions or other remote transmission, as well as any other medium or source of data that may be read by the processors of the disclosure.

For example, exemplary embodiments are intended to cover all software or computer programs capable of enabling processors to implement the operations, designs and determinations as described herein. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed herein.

These computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs and outputs over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or subnetworks, each of which may include, for example, a wired or wireless data pathway. A network may include a circuit-switched voice network, a packet-switched data network, or any other network able to carry electronic communications. For example, the network may include networks based on the Internet protocol (IP) or asynchronous transfer mode (ATM), and may support voice using, for example, Vol P, Voice-over-ATM, or other comparable protocols used for voice data communications. In one implementation, the network includes a cellular telephone network configured to enable exchange of text or SMS messages.

Examples of a network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

The database(s), memory or memories used in the processing machine that implements the disclosure may be in any of a wide variety of forms to allow the memory to hold instructions, data, or other information, as can be desired. Thus, a memory might be in the form of a database to hold data. The database might use any desired arrangement of files or data sets such as a flat file arrangement or a relational database arrangement, for example. The database can include any number of data records, tables, and/or other data structure. A table in a database can include a Primary key (PK) to identify the table. A foreign key (FK) can be an attribute in one table (entity) that links or maps to the PK of another table, so as to provide an interrelationship or mapping between tables and/or databases, for example.

In various processing described herein and illustrated by flowcharts or otherwise described, variables can be used in various processes. Such processes can include routines, subroutines, and steps, for example. The various variables can be passed between processes as may be needed in accord with the instructions provided to a processor. The various variables can be global variables that are available to the various processes, such as between a calling process and a subroutine, for example.

In the system and method of the disclosure, a variety of “user interfaces” may be utilized to allow a user to interface with the processing machine or machines that are used to implement the disclosure. As used herein, a user interface can include any hardware, software, or combination of hardware and software used by the processing machine that allows a user to interact with the processing machine and/or computer processor. A user interface may be in the form of a dialogue screen for example. A user interface may also include any of a mouse, touch screen, keyboard, voice reader, voice recognizer, dialogue screen, menu box, list, checkbox, toggle switch, a light, a pushbutton or any other device that allows a user to receive information regarding the operation of the processing machine as the processing machine processes a set of instructions and/or provide the processing machine with information. Accordingly, the user interface can be any device that provides communication between a user and a processing machine and/or computer processor. The information provided by the user to the processing machine through the user interface may be in the form of a command, a selection of data, or some other input, for example.

A user interface of the disclosure can be provided by or in the form of a user device or electronic user device. Also, systems of the disclosure can include or be in communication with one or more user devices that serve to interact or interface with a human user. A user device can be any appropriate electronic device, such as a cellular (mobile) telephone, smart phone, a tablet computer, a laptop computer, a desktop computer, an e-reader, an electronic wearable, smartwatch, gaming console, personal digital assistant (PDA), portable music player, fitness trackers with smart capabilities, and/or a server terminal, for example.

Such a user device can permit a user to input requests for information, output information, and/or process data. A user device can be in the form of and/or include a computer processor and/or a processing machine, as described herein.

As discussed above, a user interface can be utilized by the processing machine, which performs a set of instructions, such that the processing machine processes data for a user. The user interface can be typically used by the processing machine for interacting with a user either to convey information or receive information from the user. However, it should be appreciated that in accordance with some embodiments of the systems and methods of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user. Accordingly, the other processing machine might be described as a user. Further, it is contemplated that a user interface utilized in the systems and methods of the disclosure may interact partially with another processing machine or processing machines, while also interacting partially with a human user.

Features as disclosed herein may be described in context of particular units or dimensions. It is appreciated that alternative units or dimensions can be used as desired. Additionally, conversion can be performed between units or dimensions as may be desired.

In this disclosure, quotation marks, such as with the language “computer processor”, have been used to enhance readability and/or to parse out a term or phrase for clarity.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, process step, region, layer or section from another region, layer or section. Thus, a first element, component, process step, region, layer or section could be termed a second element, component, process step, region, layer or section without departing from the teachings of the present disclosure.

Spatially and organizationally relative terms, such as “lower”, “upper”, “top”, “bottom”, “left”, “right”, “north”, “south”, “east”, “west”, “up”, “down”, “right”, “left”, “upper threshold”, “lower threshold” and the like, may be used herein for ease of description to describe the relationship of one element or feature to another element(s) or feature(s) as illustrated in the drawing figures. It will be understood that spatially and organizationally relative terms are intended to encompass different orientations of or organizational aspects of components in use or in operation, in addition to the orientation or particular organization depicted in the drawing figures. For example, if a device or apparatus in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

Embodiments are also intended to include or otherwise cover methods of using and methods of manufacturing any and all of the elements disclosed above.

As used herein, “data” and “information” have been used interchangeably.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, process steps, operations, elements, and/or components, but do not preclude the presence or addition of one or more other features, integers, process steps, operations, elements, components, and/or groups thereof.

Embodiments of the disclosure are described herein with reference to diagrams, flowcharts and/or other illustrations, for example, that are schematic illustrations of idealized embodiments (and intermediate components) of the disclosure. As such, variations from the illustrations are to be expected. Thus, embodiments of the disclosure should not be construed as limited to the particular organizational depiction of components and/or processing illustrated herein but are to include deviations in organization of components and/or processing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

While the subject matter has been described in detail with reference to exemplary embodiments thereof, it will be apparent to one skilled in the art that various changes can be made, and equivalents employed, without departing from the scope of the disclosure.

All references and/or documents referenced herein are hereby incorporated by reference in their entirety.

It will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A system to assess runoff conditions for an area at a geographical location, the system including a tangibly embodied computer processor (CP) and a tangibly embodied database, the CP implementing instructions on a non-transitory computer medium disposed in the database, and the database in communication with the CP, the system comprising:
a communication portion for providing communication between the CP and a user device;
the database that includes the non-transitory computer medium, and the database including the instructions; and
the CP, and the CP performing processing including:
inputting first data regarding a first candidate operation to be considered for application to the area;
inputting second data regarding a second candidate operation to be considered for application to the area;
inputting third data including a runoff score for the area;
determining a selected candidate operation based on the runoff score, the first data and the second data.

2. The system of claim 1, wherein the selected candidate operation is applying an ingredient to the area.

3. The system of claim 1, wherein the selected candidate operation is at least one of seeding a lawn, grading a lawn, and cutting a lawn at the area.

4. The system of claim 1, the first data, regarding a first candidate operation, includes impact factors that are associated with the first candidate operation, the impact factors relating to the desirability of the first candidate operation.

5. The system of claim 4, the impact factors including a manufacturing score, a shipping score, and an application score.

6. The system of claim 4, each impact factor having a respective score; and
the determining a selected candidate operation includes:
associating each impact factor with a respective weighting to represent a degree of relevance of each impact factor; and
determining a weighted impact factor score, for each impact factor.

7. The system of claim 4, the CP performing processing including the CP interfacing with a user to select the impact factors that are associated with the first candidate operation.

8. The system of claim 7, the CP performing processing including the CP interfacing with a user to input a weighting factor for each impact factor; and
the weighting factor for each impact factor being applied in the determining a selected candidate operation.

9. The system of claim 3, the CP performing processing including the CP interfacing with a user to input a weighting factor for each impact factor; and
the weighting factor for each impact factor being applied in the determining a selected candidate operation.

10. The system of claim 1, the determining a selected candidate operation includes determining a runoff score for the area, based on the third data.

11. The system of claim 10, the determining a runoff score for the area includes:
applying an application of a sample ingredient to the area;
retrieving a target post-application of ingredient (AOI) value related to the sample ingredient;
retrieving an observed post-AOI value related to the sample ingredient; and
comparing the target post-AOI value with the observed post-AOI value to determine the runoff score.

12. The system of claim 11, the sample ingredient is sulfur, and
the target post-AOI value and the observed post-AOI value are respective pH values.

13. The system of claim 10, the determining a runoff score for the area includes:
applying an application of a physical ingredient to the area;
retrieving a pre-application of ingredient (AOI) value for the area;
retrieving a target post-AOI value;
retrieving an observed post-AOI value; and
comparing the pre-AOI value with the observed post-AOI value to generate a first differential value;
comparing the pre-AOI value with the target post-AOI value to generate a second differential value; and
comparing the first differential value with the second differential value to determine the runoff score.

14. The system of claim 1, the determining the selected candidate operation includes:
the first data including first impact factors associated with the first candidate operation, and the first impact factors associated with respective weightings;
the second data including second impact factors associated with the second candidate operation, and the second impact factors associated with respective further weightings; and
the third data including a weighting factor associated with the runoff score.

15. The system of claim 1, the determining the selected candidate operation includes:
determining, for the first candidate operation, a weighted score for each of a plurality of impact factors;
determining a weighted score for runoff of the area;
generating a weighted total score based on the weighted score of each impact factor and the weighted score for runoff of the area; and
determining that the first candidate operation has a higher weighted total score than other candidate operations, and
based on the first candidate operation having a higher weighted total score, deeming the first candidate operation as the selected candidate operation.

16. The system of claim 1, the CP performing processing further including determining the runoff score for the area, and
the determining the runoff score including:
accessing attributes of the area, the attributes including a first attribute and a second attribute; and
processing the first attribute and the second attribute in a model, so as to determine the runoff score.

17. The system of claim 16, the processing the first attribute and the second attribute in the model, so as to determine the runoff score, including:
comparing, respectively, the first attribute to corresponding first attributes of modeled areas, of the model, to generate respective first delta values;
comparing, respectively, the second attribute to corresponding second attributes of the modeled areas, of the model, to generate respective second delta values;
based on the first delta values and the second delta values, for each modeled area, generating an aggregated delta value for each modeled area;
comparing the aggregated delta value, of each modeled area, to determine which modeled area most closely corresponds to the area; and
determining the runoff score based on the modeled area that most closely corresponds to the area.

18. The system of claim 16, wherein the first attribute is soil density and the second attribute is slope of the area.

19. The system of claim 1, wherein the first candidate operation includes application of at least one ingredient selected from the group consisting of sulfur, nitrogen, nitrogen fertilizer, phosphorus, and phosphorus fertilizer.

20. An apparatus to assess runoff conditions for an area at a geographical location, the apparatus including a tangibly embodied computer processor (CP) and a tangibly embodied database, the CP implementing instructions on a non-transitory computer medium disposed in the database, and the database in communication with the CP, the apparatus comprising:
a communication portion for providing communication between the CP and a user device;
the database that includes the non-transitory computer medium, and the database including the instructions; and
the CP, and the CP performing processing including:
inputting first data regarding a first candidate operation to be considered for the area;
inputting second data regarding a second candidate operation to be considered for the area;
inputting third data including a runoff score for the area;
determining a selected candidate operation based on the runoff score, the first data and the second data, and
the first data including first impact factors associated with the first candidate operation, and the first impact factors associated with respective weightings;
the second data including second impact factors associated with the second candidate operation, and the second impact factors associated with respective further weightings; and
the determining the selected candidate operation includes:
the CP determining that the selected candidate operation is the first candidate operation based on the first data, the second data and the third data; and
one of recommending and initiating the first operation candidate to the area.

21. The apparatus of claim 20, the first candidate operation includes applying an ingredient to the area; and
the CP performing processing further including:
identifying at least one weather event that is related to applying the ingredient to the area, and
outputting a communication to a user that relates to the least one weather event.

22. A method to assess runoff conditions for an area at a geographical location, the method performed by a system including a tangibly embodied computer processor (CP) and a tangibly embodied database, the CP implementing instructions on a non-transitory computer medium disposed in the database, and the database in communication with the CP, the method comprising:
inputting first data regarding a first candidate operation to be considered for the area;
inputting second data regarding a second candidate operation to be considered for the area;
inputting third data including a runoff score for the area;
determining a selected candidate operation based on the runoff score, the first data and the second data, and
the first data including first impact factors associated with the first candidate operation, and the first impact factors associated with respective weightings;
the second data including second impact factors associated with the second candidate operation, and the second impact factors associated with respective further weightings; and
the determining the selected candidate operation includes:
the CP determining that the selected candidate operation is the first candidate operation based on the first data, the second data and the third data; and
one of recommending via a user interface and initiating via machine the selected candidate operation to the area.

23. The method of claim 22, wherein the selected candidate operation includes applying an ingredient to the area.

24. The method of claim 22, wherein the selected candidate operation is at least one of seeding a lawn, grading a lawn, and cutting a lawn at the area.
